(19) United States
(12) Patent Application Publication
(10) Pub. No.: US 2026/0181563 A1
(43) Pub. Date: Jun. 25, 2026

(54) TRANSMIT POWER SWEEPING IN RADIO FREQUENCY IDENTIFICATION (RFID) TAGS

(71) Applicant: QUALCOMM Incorporated, San Diego, CA (US)

(72) Inventors: Sheng-Yuan TU, San Diego, CA (US); Venkatraman RAJAGOPALAN, San Diego, CA (US)

(21) Appl. No.: 19/000,459

(22) Filed: Dec. 23, 2024

(51) Int. Cl. H04W 52/36; H04W 64/00; H04W 76/28

(52) U.S. Cl. CPC H04W 52/36; H04W 64/00; H04W 76/28

(57) ABSTRACT

Systems and techniques are described for wireless communications. For example, a computing device can transmit, to a plurality of first passive devices located at a first range from the computing device, a first signal with a first transmit power and a first duty cycle. The first transmit power is dependent upon the first range. The computing device can transmit, to a plurality of second passive devices located at a second range (which is less than the second range) from the computing device, a second signal with a second transmit power and a second duty cycle. The second transmit power is dependent upon the second range. The first transmit power is less than the second transmit power, and wherein the first duty cycle is greater than the second duty cycle.

### FIELD

The present disclosure generally relates to wireless communications. For example, aspects of the present disclosure relate to transmit power sweeping in radio frequency identification (RFID) tags.

### BACKGROUND

Wireless communications systems are deployed to provide various telecommunication services, including telephony, video, data, messaging, broadcasts, among others. Wireless communications systems have developed through various generations, including a first-generation analog wireless phone service (1G), a second-generation (3G) high speed data, Internet-capable wireless service, a fourth-generation (4G) service (e.g., Long-Term Evolution (LTE), WiMax), and a fifth-generation (5G) service (e.g., New Radio (NR)).

Additional examples of wireless systems include RFID systems. In an RFID system, a device (e.g., a reader) may transmit wireless signals such as continuous wave (CW) signals to one or more RFID tags, which may be referred to as energy harvesting devices. One or more tags can receive the transmitted energy and, in turn, transmit back signals (e.g., backscatter signals) to the device.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for transmit power sweeping in RFID devices (e.g., readers and/or passive devices, such as tags). In some aspects, an apparatus for wireless communications is provided. The apparatus includes a processing system configured to: output, for transmission to a plurality of first passive devices located at a first range from the apparatus, a first signal with a first transmit power and a first duty cycle, wherein the first transmit power is dependent upon the first range; and output, for transmission to a plurality of second passive devices located at a second range from the apparatus, a second signal with a second transmit power and a second duty cycle, wherein the second transmit power is dependent upon the second range, wherein the first range is less than the second range, wherein the first transmit power is less than the second transmit power, and wherein the first duty cycle is greater than the second duty cycle.

In some aspects, a method for wireless communications performed at a computing device is provided. The method includes: transmitting, to a plurality of first passive devices located at a first range from the computing device, a first signal with a first transmit power and a first duty cycle, wherein the first transmit power is dependent upon the first range; and transmitting, to a plurality of second passive devices located at a second range from the computing device, a second signal with a second transmit power and a second duty cycle, wherein the second transmit power is dependent upon the second range, wherein the first range is less than the second range, wherein the first transmit power is less than the second transmit power, and wherein the first duty cycle is greater than the second duty cycle.

In some aspects, a non-transitory computer-readable medium of a computing device is provided having stored thereon instructions that, when executed by at least one processor, cause the at least one processor to: output, for transmission to a plurality of first passive devices located at a first range from the computing device, a first signal with a first transmit power and a first duty cycle, wherein the first transmit power is dependent upon the first range; and output, for transmission to a plurality of second passive devices located at a second range from the computing device, a second signal with a second transmit power and a second duty cycle, wherein the second transmit power is dependent upon the second range, wherein the first range is less than the second range, wherein the first transmit power is less than the second transmit power, and wherein the first duty cycle is greater than the second duty cycle.

In some aspects, an apparatus for wireless communications is provided. The apparatus includes: means for transmitting, to a plurality of first passive devices located at a first range from the apparatus, a first signal with a first transmit power and a first duty cycle, wherein the first transmit power is dependent upon the first range; and means for transmitting, to a plurality of second passive devices located at a second range from the apparatus, a second signal with a second transmit power and a second duty cycle, wherein the second transmit power is dependent upon the second range, wherein the first range is less than the second range, wherein the first transmit power is less than the second transmit power, and wherein the first duty cycle is greater than the second duty cycle.

In some aspects, a passive device for wireless communications is provided. The passive device includes a processing system configured to: receive, from a computing device located at a range from the passive device, a first signal with a first transmit power and a first duty cycle; output, for transmission to the computing device based on receiving the first signal from the computing device, a first backscatter signal including information associated with the passive device; and receive, from the computing device, a second signal with a second transmit power and a second duty cycle, wherein the first transmit power is less than the second transmit power, and wherein the first duty cycle is greater than the second duty cycle.

In some aspects, a method for wireless communications performed at a passive device is provided. The method includes: receiving, from a computing device located at a range from the passive device, a first signal with a first transmit power and a first duty cycle; transmitting, to the computing device based on receiving the first signal from the computing device, a first backscatter signal including information associated with the passive device; and receiving, from the computing device, a second signal with a second transmit power and a second duty cycle, wherein the first transmit power is less than the second transmit power, and wherein the first duty cycle is greater than the second duty cycle.

In some aspects, a non-transitory computer-readable medium of a passive device is provided having stored thereon instructions that, when executed by at least one processor, cause the at least one processor to: receive, from a computing device located at a range from the passive device, a first signal with a first transmit power and a first duty cycle; output, for transmission to the computing device based on receiving the first signal from the computing device, a first backscatter signal including information associated with the passive device; and receive, from the computing device, a second signal with a second transmit power and a second duty cycle, wherein the first transmit power is less than the second transmit power, and wherein the first duty cycle is greater than the second duty cycle.

In some aspects, an apparatus for wireless communications is provided. The apparatus includes: means for receiving, from a computing device located at a range from the passive device, a first signal with a first transmit power and a first duty cycle; means for transmitting, to the computing device based on receiving the first signal from the computing device, a first backscatter signal including information associated with the passive device; and means for receiving, from the computing device, a second signal with a second transmit power and a second duty cycle, wherein the first transmit power is less than the second transmit power, and wherein the first duty cycle is greater than the second duty cycle

In some aspects, the apparatuses or other devices described herein is, can be part of, or can include a reader device (e.g., a mobile device or other type of reader device), a passive device (e.g., a tag or other type of passive device), a smart or connected device (e.g., an Internet-of-Things (IoT) device or other smart or connected device), an extended reality (XR) device (e.g., a virtual reality (VR) device, an augmented reality (AR) device, or a mixed reality (MR) device), a wearable device, a personal computer, a laptop computer, a tablet computer, a robotics device or system, an aviation system, or other device, or other type of computing device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example of a wireless communication network, in accordance with some aspects of the disclosure.

FIG. 2 is a diagram illustrating a design of a base station and a User Equipment (UE) device that enable transmission and processing of signals exchanged between the UE and the base station, in accordance with some aspects of the disclosure.

FIG. 3 is a diagram illustrating an example of a disaggregated base station, in accordance with some aspects of the disclosure.

FIG. 4 is a block diagram illustrating components of a user equipment (UE), in accordance with some aspects of the disclosure.

FIG. 5 is a diagram illustrating an example of a radio frequency (RF) energy harvesting device, in accordance with some aspects of the disclosure.

FIG. 6 is a diagram illustrating an example of a small signal rectification operation that may be associated with performing energy harvesting, in accordance with some aspects of the disclosure.

FIG. 7A is a diagram illustrating example energy harvesting characteristics between input power and harvested power, in accordance with some aspects of the disclosure.

FIG. 7B is a diagram illustrating an example of energy conversion efficiency associated with different frequencies and input powers, in accordance with some aspects of the disclosure.

FIG. 8 is a diagram illustrating an example of a radio frequency identification (RFID) inventory sequence, in accordance with some aspects of the disclosure.

FIG. 9 is a graph illustrating an example of a static RFID inventory sequence, where the sequence includes transmissions with a fixed transmit power and a fixed duty cycle, in accordance with some aspects of the disclosure.

FIG. 10 is a graph illustrating an example of a dynamic RFID inventory sequence, where the sequence includes transmissions with varying transmit powers and varying duty cycles, in accordance with some aspects of the disclosure.

FIG. 11 is a flow diagram illustrating an example of a process for wireless communications at a computing device, in accordance with some aspects of the disclosure.

FIG. 12 is a flow diagram illustrating an example of a process for wireless communications at a passive device, in accordance with some aspects of the disclosure.

FIG. 13 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communication networks can be deployed to provide various communication services, such as voice, video, packet data, messaging, broadcast, any combination thereof, or other communication services. A wireless communication network may support both access links and sidelinks for communication between wireless devices.

In various wireless communication networks, various client devices can be utilized that may be associated with different signaling and communication needs. For example, as 5G networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc. In some aspects, passive IoT devices may also be referred to as “ambient IoT devices” or simply as “passive devices”. For example, an ambient IoT device may be an IoT device that can perform ambient energy harvesting. An ambient IoT device may also be referred to as an ambient energy harvesting device. As used herein, the term “ambient IoT devices” may refer to active IoT devices, passive IoT devices, and/or semi-passive IoT devices.

In some examples, ambient IoT devices (e.g., active IoT devices, passive IoT devices, semi-passive IoT devices, etc.) are relatively low-cost devices that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. Passive and semi-passive IoT devices can include one or more sensors, a processor or micro-controller, and an energy harvester for generating electrical power from incident downlink radio frequency (RF) signals received at the passive or semi-passive IoT device.

Based on harvesting energy from incident downlink radio frequency (RF) signals (e.g., transmitted by an energy source network device such as a reader device), ambient energy harvesting devices (e.g., ambient IoT devices) may be provided without an energy storage element and/or can be provided with a relatively small energy storage element (e.g., battery, capacitor, etc.) Ambient energy harvesting devices provided without an energy storage element may include passive IoT devices. Ambient energy harvesting devices provided with a relatively small energy storage element may include semi-passive IoT devices. Ambient energy harvesting devices that are provided with an energy storage element may include active IoT devices. Energy harvesting devices can be deployed at large scales, based on the simplification in their manufacture and deployment associated with implementing wireless energy harvesting.

In some examples, ambient energy harvesting devices can harvest energy from dedicated downlink RF signals for energy harvesting. In some cases, an ambient energy harvesting device may be configured to perform energy harvesting only for dedicated downlink RF signals for energy harvesting. In some cases, ambient energy harvesting devices can harvest energy from ambient downlink RF signals (e.g., including dedicated downlink RF signals for energy harvesting and various other downlink RF signals that are not dedicated energy harvesting signals).

In some cases, an ambient energy harvesting device can use the same antenna for energy harvesting and communications. For example, an ambient energy harvesting device can use the same antenna to perform energy harvesting and backscatter communications, where the energy harvesting and the backscatter communications are based on the same downlink RF signal.

In some examples, an ambient energy harvesting device can include a first antenna used for energy harvesting and a second antenna used for communications, where the first antenna is different from the second antenna. For instance, an ambient IoT device can use the first antenna to perform energy harvesting and can use the second antenna to perform communication (e.g., transmitting and/or receiving).

The backscatter transmitter can generate and transmit an uplink signal by reflecting and backscatter modulating an incident downlink signal using the first antenna. In some examples, an ambient IoT device can use a backscatter transmitter that is the same as or similar to a backscatter transmitter utilized by a passive or semi-passive IoT device, as described above. An active transmitter can use a battery or other energy storage element included in the ambient IoT device to generate and transmit an uplink signal, using an antenna that is different from the first antenna associated with the backscatter transmitter (e.g., a second antenna). To transmit an uplink signal, the backscatter transmitter of an ambient IoT device must first receive a downlink signal that can be reflected and backscatter modulated. For example, the backscatter transmitter may be unable to transmit an uplink signal unless or until a continuous sine wave is received as a downlink signal from a reader device or other energy source network device. The active transmitter of an ambient IoT device can perform uplink communication that is triggered by the ambient IoT device (e.g., without dependence on first receiving a downlink signal). In some examples, ambient IoT devices may include a small battery or energy storage element and may be unable to sustain longer periods of uplink communication using the active transmitter of the ambient IoT device. For example, active transmission by an ambient IoT device may quickly deplete the onboard battery or other energy storage element(s) included in the ambient IoT device.

In a wireless communication network environment, a network device (e.g., such as an energizing device) can be used to transmit downlink RF signals to energy harvesting devices. In some cases, the network device can be in the form of a mobile device, such as a mobile phone. In some aspects, the network device may also be referred to herein as a “reader device”, an “energy source,” a “scheduler of energy transfer,” and/or an “energy transfer scheduler.”

Currently, passive devices, in the form of electronic tags (e.g., RFID tags), are a rapidly growing technology impacting many industries, due to their economic potential for inventory and/or asset management inside and outside warehouses, IoT devices, sustainable sensor networks in factories and/or agriculture, and smart home usage. Electronic tags consist of small transponders, or tags, that emit an information-bearing signal after receiving a signal. Electronic tags operate without a battery at a low operating expense (OPEX), with a low maintenance cost, and with a long-life cycle. Electronic tags can harvest energy over-the-air and power their transmission and reception circuitry.

In some examples, passive IoT devices can be used to provide sensing capabilities for various processes and use cases, such as asset management, logistics, warehousing, manufacturing, etc. (e.g., to monitor, track, and locate items associated with the passive IoT devices). Passive IoT devices can include one or more sensors, a processor or micro-controller, and an energy harvester for generating electrical power from incident downlink (DL) radio frequency (RF) signals received at the passive IoT device. Based on harvesting energy from incident downlink RF signals (e.g., transmitted by a network device, such as a reader device or an interrogator), energy harvesting devices (e.g., such as passive IoT devices, which may be in the form of electronic tags) can be provided with a relatively small energy storage element, such as in the form of a capacitor. Energy harvesting devices can be deployed at large scales, based on the simplification in their manufacture and deployment associated with implementing wireless energy harvesting.

In a wireless communication environment, a device (e.g., such as a reader device or interrogator) can be used to transmit downlink RF signals to energy harvesting devices. In one illustrative example, a reader device can read and/or write information stored on energy harvesting IoT devices (e.g., electronic tags, which may each be associated with a respective item) by transmitting the downlink RF signal. The downlink RF signal can provide energy to an energy harvesting IoT device. The energy harvesting IoT device can transmit (e.g., based on reflecting or backscattering a portion of the incident downlink RF signal) a response signal (e.g., an information-bearing uplink signal) back to the reader device, after the energy harvesting IoT device is sufficiently energized. The reader device can read the signal transmitted by an energy harvesting IoT device to decode the information transmitted by the IoT device (e.g., such as sensor information collected by one or more sensors included in the IoT device, etc.).

In some examples, for a given downlink signal with a given input RF power received at an ambient energy harvesting device, a first portion of the input RF power is provided to the device's energy harvester (e.g., with a percentage being converted to useful electrical power based on the conversion efficiency of the harvester, and the remaining percentage wasted or dissipated as heat, etc.). A remaining, second portion of the input RF power is available for use in the backscattered uplink transmission (e.g., the second portion of the input power is reflected and modulated with the uplink communication).

An energy harvesting tag (EH-tag) system is an ambient IoT system. The system generally includes an energizer (e.g., a reader device or interrogator) and an electronic tag (e.g., which is a low cost device). An electronic tag does not include a battery and relies on wireless power transfer (WPT) from over-the-air to perform energy harvesting (e.g., to harvest energy from the wireless signals transmitted from the energizer). The energizer can send a downlink wireless power transfer waveform (e.g., including a continuous waveform (CW)) to the electronic tags.

RFID transmissions involve high power transmissions. For example, ultra-high frequency (UHF) RFID is currently widely used for long ranges (e.g., greater than a ten meters range) for inventory and stock management in warehouses (or retail stores) for industrial Internet of Things (IoT) devices (e.g., RFID tags). UHF RFID operates at a frequency range of 860 to 930 megahertz (MHz) globally. GS1 electronic product code (EPC) Class 1 Gen 2 and international organization for standardization (ISO) 18000-63 outline the UHF RFID air interface protocol (e.g., for wireless communications between reader devices and tags). In particular, the RFID air interface protocol defines that a single reader device can communicate with multiple passive tags (e.g., RFID tags) to extract product serial numbers (e.g., tag identifications (TIDs)) of the tags and/or to perform read/write access to the tags.

Currently, the majority of RFID solutions are based on bulky gun-form factor devices (e.g., handheld computing devices in the shape of a gun) or attachable RFID devices. For the solutions employing the attachable RFID devices, users (e.g., businesses or customers) need to purchase a separate attachable RFID device to attach to a handheld device (e.g., a mobile phone) for performing RFID operations (e.g., inventory of RFID tags). The gun-form factor devices and attachable RFID devices can provide high performance (e.g., a long range and a high read rate), but are very costly (e.g., around a thousand dollars each).

Integrated RFID solutions, that integrate RFID devices within handheld devices (e.g., a mobile phone), are emerging due to their low cost and new use cases. The performance of these integrated handheld devices is sufficient to enable use cases with shorter ranges (e.g., approximately two meters) for warehouse or retail store inventory, or with extremely short ranges (e.g., approximately five centimeters) for product returns and checkout services. In order to meet these shorter ranges (e.g., approximately two meters), the power amplifier (PA) of the transmitter of these handheld devices needs to deliver much higher power (e.g., thirty decibel-milliwatts (dBm), such as in an RFID burst operation) to the antenna of the handheld device, as compared to typical wide area network (WAN) radios.

Reader device-to-tag and tag-to-reader device communications are half-duplex and separate in time. However, since a reader device needs to supply power to energize the tags (e.g., RFID tags), the reader device may continuously transmit a CW, even outside of the reader device-to-tag data transmissions. The passive tags (e.g., RFID tags) can reflect and modulate the CW, received from reader device, during the tag-to-reader devices communications.

Performing inventory of tags (e.g., RFID tags) located within a warehouse or retail store can take a long amount of time, such as in the order of minutes in duration. As such, RFID inventory operations can significantly drain the battery of the handheld device. In addition, the duty cycle of the RFID inventory operations must be significantly reduced in order to meet stringent RF exposure (e.g., specific absorption rate (SAR)) requirements for handheld devices (e.g., mobile devices, such as mobile phones). The duty cycle directly relates to the read rate (e.g., a rate of the number of tags read per second), which is a key performance indicator (KPI) of the reader devices.

As such, improved systems and techniques for performing inventory of tags (e.g., RFID tags) that conserve power (e.g., saves battery power) in integrated handheld devices (e.g., reader devices) can be beneficial.

In some aspects of the present disclosure, systems, apparatuses, methods (also referred to as processes), and computer-readable media (collectively referred to herein as “systems and techniques”) are described herein for transmit power sweeping in RFID tags.

Various aspects relate generally to wireless communications. Some aspects more specifically relate to systems and techniques that provide solutions for adaptively adjusting the transmit power of an energizing signal transmitted from a reader device (e.g., an integrated handheld device) to scan tags (e.g., RFID tags) located in various different ranges from the reader device. The duty cycle of the energizing signal may be varied, such as to comply with RF exposure and/or to maintain an average read rate for reading the tags. An inventory state of the tags may be set (e.g., changed) such that inventoried tags do not respond to the reader device repetitively, which can be redundant and cause unnecessary air interference.

Particular aspects of the subject matter described in this disclosure can be implemented to realize one or more of the following potential advantages. In one or more examples, the systems and techniques have the benefit of providing a reduction in reader device-to-reader device interference in a multi-reader device environment. For example, when there are multiple reader devices operating within a vicinity (e.g., close proximity) of each other, a fixed high transmit power (e.g., which is currently typically employed) of energizing signals transmitted from other reader devices can interfere with the tag-to-reader device communications. This fixed high transmit power can increase the air interference. The systems and techniques employ a variable transmit power for energizing signals transmitted from reader devices that can meet the coverage area (e.g., ranges) of the tags to be inventoried, reduce the air interference, and improve the overall network efficiency.

In one or more examples, during operation of the systems and techniques for wireless communications performed at a computing device, the computing device can transmit, to a plurality of first passive devices located at a first range from the computing device, a first signal with a first transmit power and a first duty cycle. In one or more examples, the first transmit power can be dependent upon the first range. The computing device can transmit, to a plurality of second passive devices located at a second range from the computing device, a second signal with a second transmit power and a second duty cycle. In one or more examples, the second transmit power can be dependent upon the second range. In some examples, the first range can be less than the second range. In one or more examples, the first transmit power can be less than the second transmit power. In some examples, the first duty cycle can be greater than the second duty cycle.

In one or more examples, the computing device can receive a respective first backscatter signal from each first passive device of the plurality of first passive devices in response to the plurality of first passive devices receiving the first signal. The computing device can receive a respective second backscatter signal from each second passive device of the plurality of second passive devices in response to the plurality of second passive devices receiving the second signal.

In some examples, the computing device can transmit, to a plurality of third passive devices located at a third range from the computing device, a third signal with a third transmit power and a third duty cycle. In one or more examples, the third transmit power can be dependent upon the third range. In some examples, the third range can be greater than the second range. In one or more examples, the third transmit power can be greater than the second transmit power. In some examples, the third duty cycle can be less than the second duty cycle. In one or more examples, the computing device can receive a respective third backscatter signal from each third passive device of the plurality of third passive devices in response to the plurality of third passive devices receiving the third signal.

In one or more examples, the first duty cycle can be inversely proportional to the first transmit power. In some examples, the second duty cycle can be inversely proportional to the second transmit power. In one or more examples, the first duty cycle and the second duty cycle can be each dependent upon an RF exposure (e.g., SAR) requirement for the computing device. In some examples, the first signal and the second signal can each include a respective CW. In one or more examples, the computing device can be a mobile device. In some examples, each first passive device of the plurality of first passive devices can be a RFID tag. In one or more examples, each second passive device of the plurality of second passive devices can be an RFID tag.

In some examples, during operation of the systems and techniques for wireless communications performed at a passive device, the passive device can receive, from a computing device located at a range from the passive device, a first signal with a first transmit power and a first duty cycle. In one or more examples, the first transmit power can be dependent upon the range. The passive device can transmit, to the computing device based on receiving the first signal from the computing device, a first backscatter signal including information associated with the passive device. The passive device can receive, from the computing device, a second signal with a second transmit power and a second duty cycle. In one or more examples, the first transmit power can be less than the second transmit power. In some examples, the first duty cycle can be greater than the second duty cycle.

In one or more examples, the passive device can change, based on transmitting the first backscatter signal to the computing device, an inventory state of the passive device from a first state to a second state. In some examples, the passive device can change, based on expiration of a specific duration of time, the inventory state of the passive device from the second state to the first state. In one or more examples, the passive device can transmit, to the computing device based on receiving the second signal from the computing device and on the inventory state being changed from the second state to the first state, a second backscatter signal. In some examples, the passive device cannot transmit backscatter signals until the inventory state of the passive device has been changed from the second state to the first state.

In some examples, the information associated with the passive device can include a tag identification (TID) and/or an EPC. In one or more examples, the passive device can be an RFID tag. In some examples, the computing device can be a mobile device.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

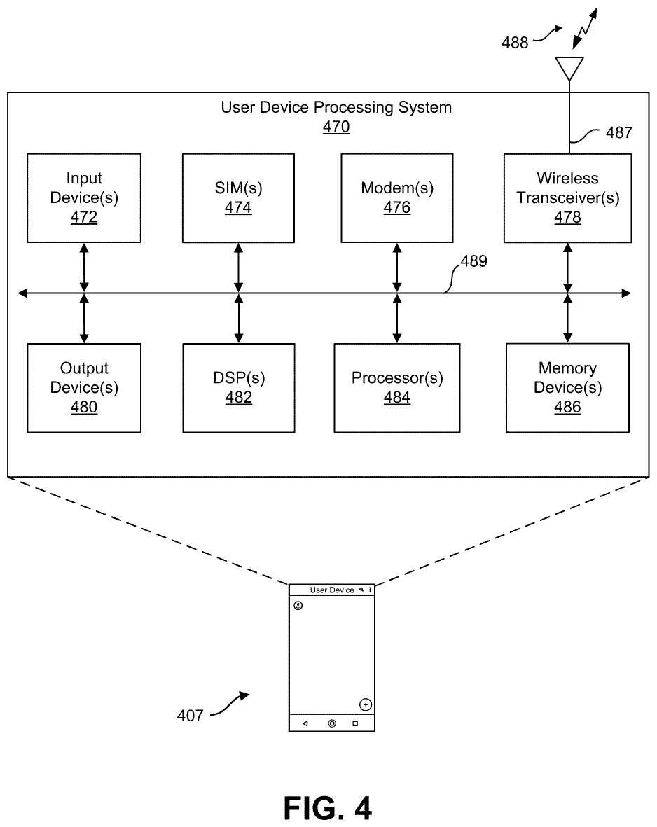

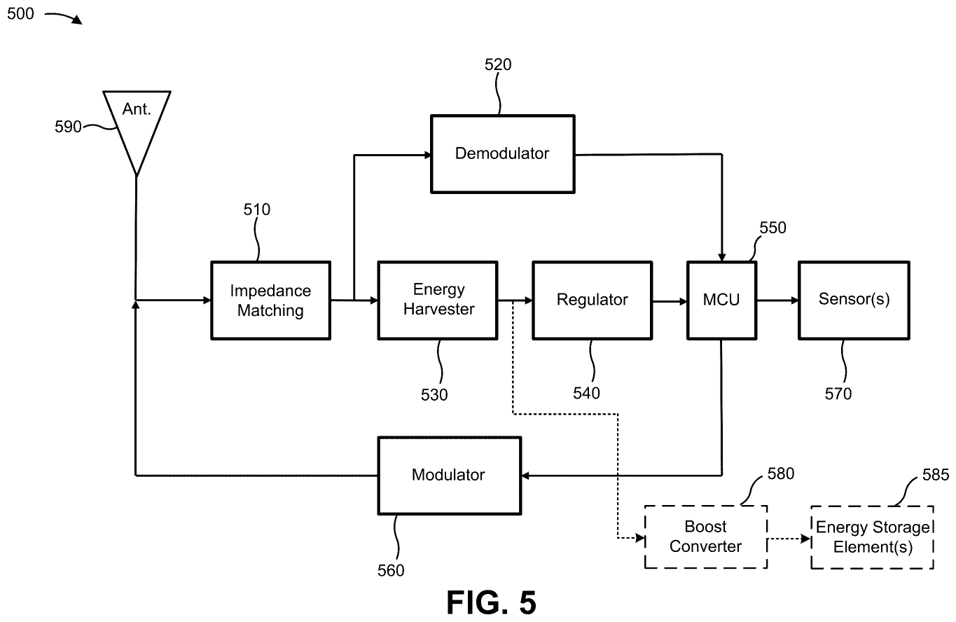

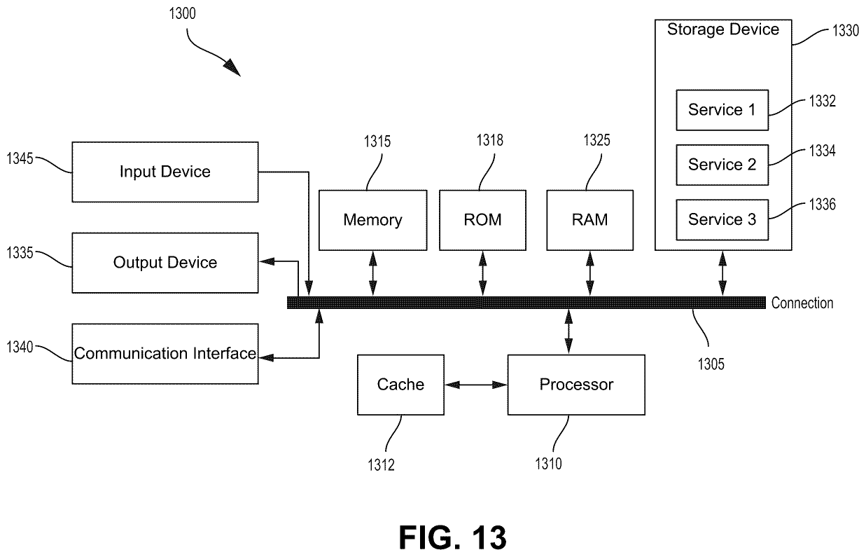

In some examples, any of the devices and/or apparatuses described herein (e.g., a passive device such as the RF energy harvesting device 500 of FIG. 5, any of the passive devices described herein, any of the reader devices described herein, and/or other device) may include a processing system (e.g., such as the processing system 470 of FIG. 4, a processing system similar to that of the RF energy harvesting device 500 of FIG. 5, and/or the processing system 1310 of FIG. 13, etc.). A processing system may include one or more components (or subcomponents), such as one or more components described herein. For example, a respective component of the one or more components may be, be similar to, include, or be included in at least one memory, at least one communication interface, and/or at least one processor. In some cases, the one or more components may include a first component, a second component, and/or a third component. In one illustrative example, the processing system can include the first component and the second component, where the first component may be coupled to the second component. In this example, the first component may be at least one processor and the second component may be at least one memory. In another illustrative example, the processing system can include the first component, the second component, and the third component, where the first component may be coupled to the second component and the third component. In this example, the first component may be at least one processor, the second component may be at least one memory, and the third component may be a communication interface.

A processing system may generally be a system including one or more components that may perform one or more functions, such as any function or combination of functions described herein. For example, one or more components (e.g., at least one communication interface) may receive input information (e.g., any information that is an input, such as a signal, any digital information, or any other information), one or more components (e.g., at least one processor) may process the input information to generate output information (e.g., any information that is an output, such as a signal or any other information), one or more components (e.g., at least one memory) may store information (e.g., the processed input information), one or more components may perform any other function(s) as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, one or more devices described herein, such as a passive device, a server, a reader device, and/or other device).

For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a device described herein (e.g., a passive device, a server, a reader device, etc.) may interface with one or more other components of the device, May process information received from one or more other components (such as input information), or may output information to one or more other components. For example, a processing system may include a first component configured to interface with one or more other components of the device to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip (e.g., a chipset, a system-on-chip (SoC), modem, etc.) of the device may include a processing system. The processing system may include a first communication interface to receive or obtain information, and a second communication interface to output, transmit, and/or otherwise provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

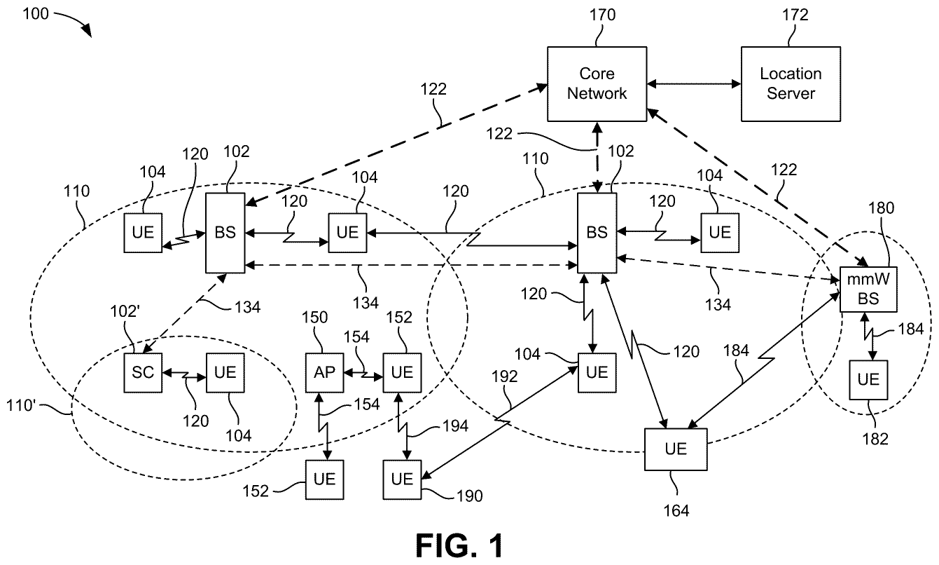

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers May be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

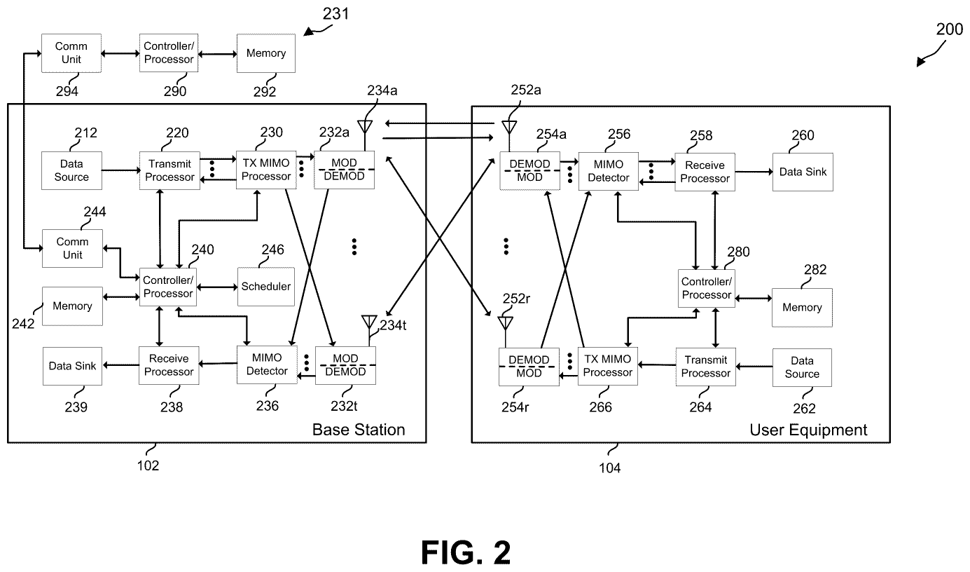

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

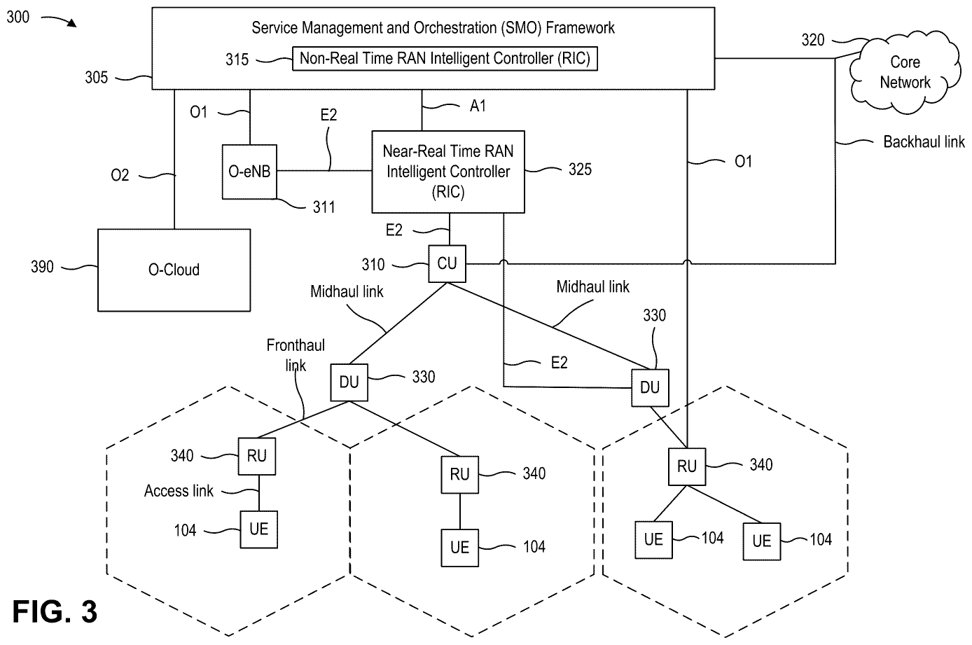

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

FIG. 4 illustrates an example of a processing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The processing system 470 includes software and hardware components that may be electrically or communicatively coupled via a bus 489 (e.g., or may otherwise be in communication, as appropriate). For example, the processing system 470 includes one or more processors 484. The one or more processors 484 may include one or more CPUs, ASICS, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network. In some cases, the antenna may be configured to emit continuous wave communications that can stimulate energy in an energy harvesting device (e.g., a RFID tag) such as energy harvesting device 500 shown in FIG. 5. In some cases, the antenna may be configured to receive RFID communications from such an energy harvesting device.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the AES and/or DES standard) transmitted and/or received by the one or more wireless transceivers 478.

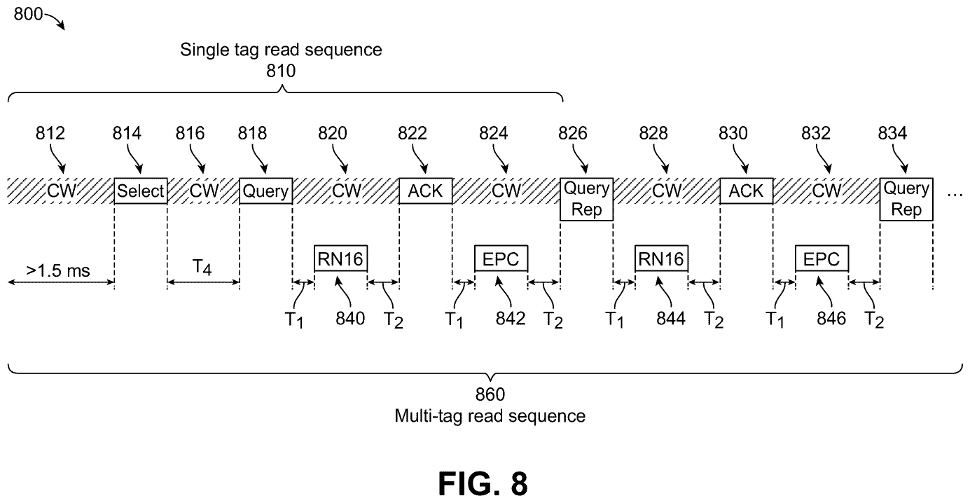

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474. In some examples, the one or more wireless transceivers 478 may be able to process or modulate signals such as continuous wave signals and/or receive and demodulate signals received from an RFID tag or energy harvesting device. An example of RFID signals is shown further with respect to FIG. 8.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

In some examples, ambient IoT devices (e.g., active IoT devices, passive IoT devices, semi-passive IoT devices, etc.) are relatively low-cost UEs that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. Passive and semi-passive IoT devices can include one or more sensors, a processor or micro-controller, and an energy harvester for generating electrical power from incident downlink radio frequency (RF) signals received at the passive or semi-passive IoT device.

Based on harvesting energy from incident downlink RF signals (e.g., transmitted by an energy source network device such as a base station, gNB, etc.), ambient energy harvesting devices (e.g., ambient IoT devices) may be provided without an energy storage element and/or can be provided with a relatively small energy storage element (e.g., battery, capacitor, etc.) Ambient energy harvesting devices provided without an energy storage element may include passive IoT devices. Ambient energy harvesting devices provided with a relatively small energy storage element may include semi-passive IoT devices. Ambient energy harvesting devices that are provided with an energy storage element may include active IoT devices. Energy harvesting devices can be deployed at large scales, based on the simplification in their manufacture and deployment associated with implementing wireless energy harvesting.

In some examples, ambient energy harvesting devices can harvest energy from dedicated downlink RF signals for energy harvesting. In some cases, an ambient energy harvesting device may be configured to perform energy harvesting only for dedicated downlink RF signals for energy harvesting. In some cases, ambient energy harvesting devices can harvest energy from ambient downlink RF signals (e.g., including dedicated downlink RF signals for energy harvesting and various other downlink RF signals that are not dedicated energy harvesting signals).

In some cases, an ambient energy harvesting device can use the same antenna for energy harvesting and communications. For example, an ambient energy harvesting device can use the same antenna to perform energy harvesting and backscatter communications, where the energy harvesting and the backscatter communications are based on the same downlink RF signal. In some examples, an ambient energy harvesting device can include a first antenna used for energy harvesting and a second antenna used for communications, where the first antenna is different from the second antenna. For instance, an ambient IoT device can use the first antenna to perform energy harvesting and can use the second antenna to perform communication (e.g., transmitting and/or receiving).

The backscatter transmitter can generate and transmit an uplink signal by reflecting and backscatter modulating an incident downlink signal using the first antenna. In some examples, an ambient IoT device can use a backscatter transmitter that is the same as or similar to a backscatter transmitter utilized by a passive or semi-passive IoT device, as described above. An active transmitter can use a battery or other energy storage element included in the ambient IoT device to generate and transmit an uplink signal, using an antenna that is different from the first antenna associated with the backscatter transmitter (e.g., a second antenna). To transmit an uplink signal, the backscatter transmitter of an ambient IoT device must first receive a downlink signal that can be reflected and backscatter modulated. For example, the backscatter transmitter may be unable to transmit an uplink signal unless or until a continuous sine wave is received as a downlink signal from a base station, gNB, or other energy source network device. The active transmitter of an ambient IoT device can perform uplink communication that is triggered by the ambient IoT device (e.g., without dependence on first receiving a downlink signal). In some examples, ambient IoT devices may include a small battery or energy storage element and may be unable to sustain longer periods of uplink communication using the active transmitter of the ambient IoT device. For example, active transmission by an ambient IoT device may quickly deplete the onboard battery or other energy storage element(s) included in the ambient IoT device.

FIG. 5 is a diagram illustrating an example of an architecture of a radio frequency (RF) energy harvesting device 500, in accordance with some examples. As will be described in greater depth below, the RF energy harvesting device 500 can harvest RF energy from one or more RF signals received using an antenna 590. As used herein, the term “energy harvesting” may be used interchangeably with “power harvesting.” In some aspects, energy harvesting device 500 can be implemented as an Internet-of-Things (IoT) device, can be implemented as a sensor, etc., as will be described in greater depth below. In other examples, energy harvesting device 500 can be implemented as a Radio-Frequency Identification (RFID) tag or various other RFID devices.

The energy harvesting device 500 includes one or more antennas 590 that can be used to transmit and receive one or more wireless signals. For example, energy harvesting device 500 can use antenna(s) 590 to receive one or more downlink signals and to transmit one or more uplink signals. An impedance matching component 510 can be used to match the impedance of antenna(s) 590 to the impedance of one or more (or all) of the receive components included in energy harvesting device 500. In some examples, the receive components of energy harvesting device 500 can include a demodulator 520 (e.g., for demodulating a received downlink signal), an energy harvester 530 (e.g., for harvesting RF energy from the received downlink signal), a regulator 540, a micro-controller unit (MCU) 550, a modulator 560 (e.g., for generating an uplink signal). In some cases, the receive components of energy harvesting device 500 may further include one or more sensors 570.

The downlink signals can be received from one or more transmitters. For example, energy harvesting device 500 may receive a downlink signal from a network node or network entity that is included in a same wireless network as the energy harvesting device 500. In some cases, the network entity can be a base station, gNB, etc., that communicates with the energy harvesting device 500 using a cellular communication network. For example, the cellular communication network can be implemented according to the 3G, 4G, 5G, and/or other cellular standard (e.g., including future standards such as 6G and beyond).

In some cases, energy harvesting device 500 can be implemented as a passive or semi-passive energy harvesting device (e.g., an ambient energy harvesting device), which can perform passive uplink communication by modulating and reflecting a downlink signal received via antenna(s) 590. For example, passive and semi-passive energy harvesting devices may be unable to generate and transmit an uplink signal without first receiving a downlink signal that can be modulated and reflected. In other examples, energy harvesting device 500 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An ambient energy harvesting device (e.g., active or semi-passive energy harvesting device) may include one or more energy storage elements 585 (e.g., collectively referred to as an “energy reservoir”). For example, the one or more energy storage elements 585 can include batteries, capacitors, etc. In some examples, the one or more energy storage elements 585 may be associated with a boost converter 580. The boost converter 580 can receive as input at least a portion of the energy harvested by energy harvester 530 (e.g., with a remaining portion of the harvested energy being provided as instantaneous power for operating the energy harvesting device 500). In some aspects, the boost converter 580 may be a step-up converter that steps up voltage from its input to its output (e.g., and steps down current from its input to its output). In some examples, boost converter 580 can be used to step up the harvested energy generated by energy harvester 530 to a voltage level associated with charging the one or more energy storage elements 585. An ambient energy harvesting device (e.g., active or semi-passive energy harvesting device) may include one or more energy storage elements 585 and may include one or more boost converters 580. A quantity of energy storage elements 585 may be the same as or different than a quantity of boost converters 580 included in an active or semi-passive energy harvesting device.

A passive energy harvesting device does not include an energy storage element 585 or other on-device power source. For example, a passive energy harvesting device may be powered using only RF energy harvested from a downlink signal (e.g., using energy harvester 530). As mentioned previously, a semi-passive energy harvesting device can include one or more energy storage elements 585 and/or other on-device power sources. The energy storage element 585 of a semi-passive energy harvesting device can be used to augment or supplement the RF energy harvested from a downlink signal. In some cases, the energy storage element 585 of a semi-passive energy harvesting device may store insufficient energy to transmit an uplink communication without first receiving a downlink communication (e.g., minimum transmit power of the semi-passive device>capacity of the energy storage element). An active energy harvesting device can include one or more energy storage elements 585 and/or other on-device power sources that can power uplink communication without using supplemental harvested RF energy (e.g., minimum transmit power of the active device<capacity of the energy storage element). The energy storage element(s) 585 included in an active energy harvesting device and/or a semi-passive energy harvesting device can be charged using harvested RF energy.

As mentioned above, ambient energy harvesting devices (e.g., passive and semi-passive energy harvesting devices) transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, ambient energy harvesting devices (e.g., passive and semi-passive energy harvesting devices) may be unable to transmit an uplink signal (e.g., passive communication). Active energy harvesting devices do not depend on receiving a downlink signal in order to transmit an uplink signal and can transmit an uplink signal as desired (e.g., active communication).

In examples in which the energy harvesting device 500 is implemented as an ambient energy harvesting device (e.g., a passive or semi-passive energy harvesting device), a continuous carrier wave downlink signal may be received using antenna(s) 590 and modulated (e.g., re-modulated) for uplink communication. In some cases, a modulator 560 can be used to modulate the reflected (e.g., backscattered) portion of the downlink signal. For example, the continuous carrier wave may be a continuous sinusoidal wave (e.g., sine or cosine waveform) and modulator 560 can perform modulation based on varying one or more of the amplitude and the phase of the backscattered reflection. Based on modulating the backscattered reflection, modulator 560 can encode digital symbols (e.g., such as binary symbols or more complex systems of symbols) indicative of an uplink communication or data message. For example, the uplink communication may be indicative of sensor data or other information associated with the one or more sensors 570 included in energy harvesting device 500.

As mentioned previously, impedance matching component 510 can be used to match the impedance of antenna(s) 590 to the receive components of energy harvesting device 500 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna(s) 590. Based on varying the antenna impedance (e.g., varying the impedance mismatch between antenna(s) 590 and the remaining components of energy harvesting device 500), digital symbols and/or binary information can be encoded (e.g., modulated) onto the backscattered reflection. Varying the antenna impedance to modulate the phase and/or amplitude of the backscattered reflection can be performed using modulator 560.

As illustrated in FIG. 5, a portion of a downlink signal received using antenna(s) 590 can be provided to a demodulator 520, which performs demodulation and provides a downlink communication (e.g., carried or modulated on the downlink signal) to a micro-controller unit (MCU) 550 or other processor included in the energy harvesting device 500. A remaining portion of the downlink signal received using antenna(s) 590 can be provided to energy harvester 530, which harvests RF energy from the downlink signal. For example, energy harvester 530 can harvest RF energy based on performing AC-to-DC (alternating current-to-direct current) conversion, wherein an AC current is generated from the sinusoidal carrier wave of the downlink signal and the converted DC current is used to power the energy harvesting device 500. In some aspects, energy harvester 530 can include one or more rectifiers for performing AC-to-DC conversion. A rectifier can include one or more diodes or thin-film transistors (TFTs). In one illustrative example, energy harvester 530 can include one or more Schottky diode-based rectifiers. In some cases, energy harvester 530 can include one or more TFT-based rectifiers.

The output of the energy harvester 530 is a DC current generated from (e.g., harvested from) the portion of the downlink signal provided to the energy harvester 530. In some aspects, the DC current output of energy harvester 530 may vary with the input provided to the energy harvester 530. For example, an increase in the input current to energy harvester 530 can be associated with an increase in the output DC current generated by energy harvester 530. In some cases, MCU 550 may be associated with a narrow band of acceptable DC current values. Regulator 540 can be used to remove or otherwise decrease variation(s) in the DC current generated as output by energy harvester 530. For example, regulator 540 can remove or smooth spikes (e.g., increases) in the DC current output by energy harvester 530 (e.g., such that the DC current provided as input to MCU 550 by regulator 540 remains below a first threshold). In some cases, regulator 540 can remove or otherwise compensate for drops or decreases in the DC current output by energy harvester 530 (e.g., such that the DC current provided as input to MCU 550 by regulator 540 remains above a second threshold).

In some aspects, the harvested DC current (e.g., generated by energy harvester 530 and regulated upward or downward as needed by regulator 540) can be used to power MCU 550 and one or more additional components included in the energy harvesting device 500. For example, the harvested DC current can additionally be used to power one or more (or all) of the impedance matching component 510, demodulator 520, regulator 540, MCU 550, sensors 570, modulator 560, etc. For example, sensors 570 and modulator 560 can receive at least a portion of the harvested DC current that remains after MCU 550 (e.g., that is not consumed by MCU 550). In some cases, the harvested DC current output by regulator 540 can be provided to MCU 550, modulator 560, and sensors 570 in series, in parallel, or a combination thereof.

In some examples, sensors 570 can be used to obtain sensor data (e.g., such as sensor data associated with an environment in which the energy harvesting device 500 is located). Sensors 570 can include one or more sensors, which may be of a same or different type(s). In some aspects, one or more (or all) of the sensors 570 can be configured to obtain sensor data based on control information included in a downlink signal received using antenna(s) 590. For example, one or more of the sensors 570 can be configured based on a downlink communication obtained based on demodulating a received downlink signal using demodulator 520. In one illustrative example, sensor data can be transmitted based on using modulator 560 to modulate (e.g., vary one or more of amplitude and/or phase of) a backscatter reflection of the continuous carrier wave received at antenna(s) 590. Based on modulating the backscattered reflection, modulator 560 can encode digital symbols (e.g., such as binary symbols or more complex systems of symbols) indicative of an uplink communication or data message. In some examples, modulator 560 can generate an uplink, backscatter modulated signal based on receiving sensor data directly from sensors 570. In some examples, modulator 560 can generate an uplink, backscatter modulated signal based on received sensor data from MCU 550 (e.g., based on MCU 550 receiving sensor data directly from sensors 570).

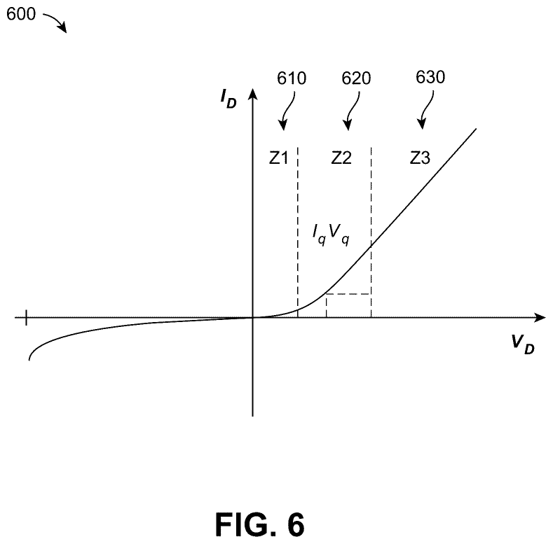

FIG. 6 is a diagram 600 illustrating an example of a small signal rectification operation that may be associated with performing energy harvesting, in accordance with some examples. In one illustrative example, the small signal rectification operation may be a small signal rectification operation associated with a Schottky diode barrier (e.g., a Schottky diode used to perform rectification associated with energy harvester 530 illustrated in FIG. 5).

In some cases, the rectification process in a diode barrier (e.g., Schottky diode or other diode) associated with performing energy harvesting can be classified into small signal operation and large signal operation. For example, large signal operation is associated with rectifying an input signal (e.g., a received downlink signal at an energy harvesting device that includes the diode) having a relatively large amplitude signal that causes the diode to operate in its resistive zone. Small signal operation (e.g., such as the example small signal operation illustrated in FIG. 6) can be associated with rectifying an input signal (e.g., or portion thereof) having a relatively small amplitude signal, such that the diode does not operate in its resistive zone.

For example, small signal operation of a rectifying process in a Schottky diode barrier may be associated with three different operating zones, as depicted in FIG. 6. In a first operating zone 610, the diode behavior may be approximated as quadratic. For example, in the first operating zone 610, the output signal of the diode may be proportional to the square of the input signal to the diode. In some cases, the first operating zone 610 may also be referred to as a square law zone. In a second operating zone 620, the diode behavior may become more affected by other contributions, and the relationship between the output-input signal of the diode may decrease from quadratic towards linear. In some cases, the second operating zone 620 may also be referred to as a transition zone. In a third operating zone 630, the output signal of the diode may be proportional to the input signal to the diode (e.g., a linear relationship between input and output signals of the diode) and no DC component is generated. The third operating zone 630 may also be referred to as a resistive zone.

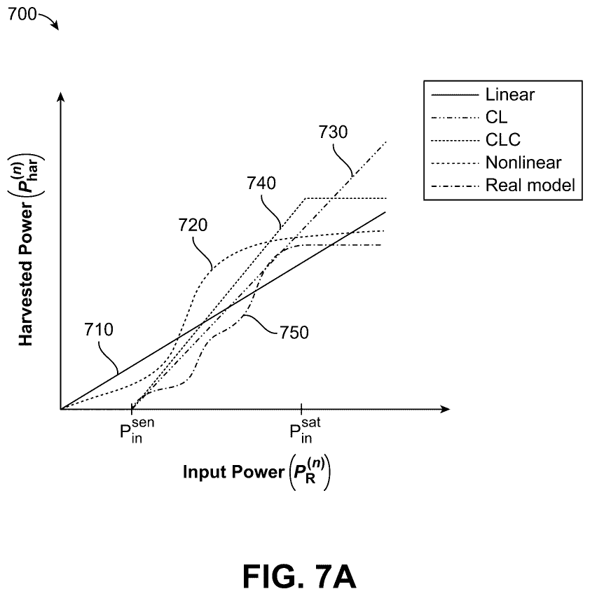

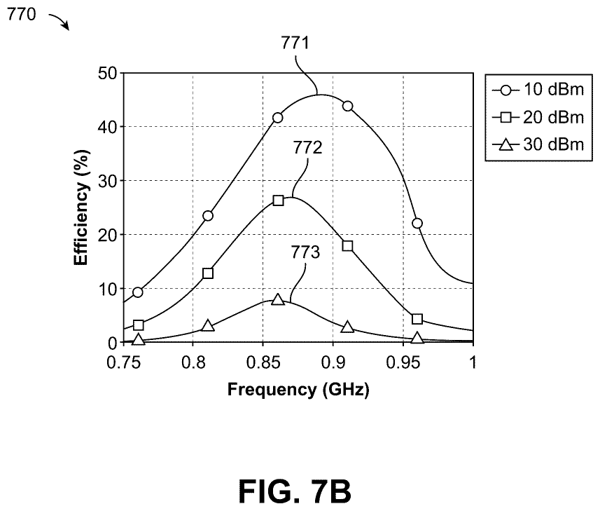

FIG. 7A is a diagram 700 illustrating examples of input power-harvested power conversion models that may be associated with various energy harvesting devices (e.g., such as the energy harvesting device 500 illustrated in the example of FIG. 5, above). Diagram 700 includes a first power conversion model 710, a second power conversion model 720, a third power conversion model 730, a fourth power conversion model 740, and a fifth power conversion model 750. In some aspects, different energy harvesting devices may be associated with different models between input power (e.g., the total RF energy or power of the portion of the received downlink signal provided to energy harvester 530 illustrated in FIG. 5) and harvested power (e.g., the RF energy or power that is harvested and output by energy harvester 530). In some aspects, the power conversion models 710-750 may be associated with ambient energy harvesting devices (e.g., passive and/or semi-passive energy harvesting devices) and/or active energy harvesting devices.

The first power conversion model 710 can be associated with a first type or category of energy harvesting devices. For example, energy harvesting devices having the first power conversion model 710 can provide harvested power as a continuous, linear, increasing function of the input RF power.

The second power conversion model 720 can be associated with a second type or category of energy harvesting devices. For example, energy harvesting devices having the second power conversion model 720 can provide harvested power as a continuous, non-linear, increasing function of the input RF power.

The third power conversion model 730 can be associated with a third type or category of energy harvesting device. For example, energy harvesting devices having the third power conversion model 730 can provide harvested power that is a continuous, linear, increasing function of the input RF power, given that the input RF power is above a sensitivity threshold

$$( {P}_{i n}^{s e n} ) .$$

The sensitivity threshold

$${P}_{i n}^{s e n}$$

can represent a minimum input RF power for which the energy harvesting device is able to perform harvesting (e.g., is able to harvest a non-zero amount of power). When the input RF power is below the sensitivity

$$( {P}_{i n}^{s e n} ) ,$$

the harvested power is zero.

The fourth power conversion model 740 can be associated with a fourth type or category of energy harvesting device. For example, energy harvesting devices having the fourth power conversion model 740 can provide harvested power that is a continuous, linear, increasing function of the input RF power, given that the input RF power is both above the sensitivity threshold

$${P}_{i n}^{s e n}$$

and is below a saturation threshold

$${P}_{i n}^{sat} .$$

As illustrated, the saturation threshold

$${P}_{i n}^{sat}$$

is greater than a sensitivity threshold

$${P}_{i n}^{s e n} .$$

When the input RF power is below the sensitivity threshold

$${P}_{i n}^{s e n} ,$$

the harvested power is zero. When the input RF power is above the saturation threshold

$${P}_{i n}^{sat} ,$$

the harvested power output saturates (e.g., remains approximately constant for any input RF power above the saturation threshold).

The fifth power conversion model 750 can be associated with a fifth type or category of energy harvesting device. For example, for an input RF power between the sensitivity threshold

$${P}_{i n}^{s e n}$$

and the saturation threshold

$${P}_{i n}^{sat} ,$$

energy harvesting devices having the fifth power conversion model 750 can provide harvested power that is a continuous, non-linear, increasing function of the input RF power.

In some examples, an efficiency of an energy harvesting device can be determined as a percentage of the input RF power that is converted into harvested power. FIG. 7B is a diagram 770 illustrating an example of energy conversion efficiency vs. frequency (e.g., of an input waveform to the energy harvesting device) for different input powers. For example, a first efficiency-frequency relationship 771 is shown for an input RF power of −10 dBm (decibel milliwatts), a second efficiency-frequency relationship 772 is shown for an input RF power of −20 dBm, and a third efficiency-frequency relationship 773 is shown for an input RF power of −30 dBm.

The three efficiency-frequency relationships 771, 772, 773 depicted in FIG. 7B may each be associated with an optimum operating frequency, or an optimum operating frequency band, for which the energy conversion efficiency of a corresponding energy harvesting device is maximized. For example, for an input RF power of −30 dBm, an energy harvesting device with the third energy conversion model 773 may maximize its energy conversion efficiency with an input RF waveform centered at a frequency of 0.86 GHz. In another example, for an input RF power of −20 dBm, an energy harvesting device with the second energy conversion model 772 may maximize its energy conversion efficiency with an input RF waveform centered at a frequency of 0.87 GHz. In another example, for an input RF power of −10 dBm, an energy harvesting device with the first energy conversion model 771 may maximize its energy conversion efficiency with an input RF waveform centered at a frequency of 0.89 GHz.

The efficiency of an energy harvesting device may vary based on the input RF power (e.g., the RF power of the downlink signal received at an antenna of the energy harvesting device) and the center frequency of the input RF waveform. For example, as illustrated in FIG. 7B, the maximum or peak efficiency of an energy harvesting device that receives a relatively low input RF power may be less than the maximum or peak efficiency of an energy harvesting device that receives a relatively high input RF power (e.g., at −30 dBm the peak efficiency of energy conversion model 773 is below 10%, at −20 dBm the peak efficiency of energy conversion model 772 is approximately 25%, and at −10 dBm the peak efficiency of energy conversion model 771 is approximately 45%). In some cases, conversion efficiency can decrease for frequencies that are greater than the optimum input center frequency and can decrease for frequencies that are less than the optimum input center frequency.

In some aspects, the conversion efficiency of an energy harvesting device may be associated with one or more energy conversion characteristics (e.g., also referred to as energy harvesting characteristics). For example, one or more characteristics may be indicative of a relationship between the conversion efficiency of an energy harvesting device and input frequency. In one illustrative example, an energy harvesting device may have an approximately constant conversion efficiency over a narrowband operating bandwidth (e.g., such as 20 MHz or less). In such examples, the energy harvesting device can receive RF energy from a multi-sine downlink wave with uniform power distribution. In another illustrative example, an energy harvesting device with a wideband operating bandwidth (e.g., such as 20 MHz or greater) may have a conversion efficiency that is a non-linear function of input frequency over the wideband. In such examples, the energy harvesting device may receive RF energy based on Gaussian and/or raised-cosine filters being used in combination with (e.g., on top of) the multi-sine downlink wave described above for narrowband operating bandwidths.

In some aspects, the energy conversion efficiency of an energy harvesting device may vary continuously with the input RF power. For example, the energy conversion efficiency may be zero for input powers less than the sensitivity threshold

$$( {P}_{i n}^{s e n} )$$

(e.g., based on the harvested power being equal to zero when the input RF power is below the sensitivity threshold, and conversion efficiency=harvested power/input RF power). In some examples, the energy conversion efficiency of an energy harvesting device may vary over different input frequencies (e.g., as described above with respect to FIG. 7B) and may additionally vary over different input RF powers. For example, in some cases the energy conversion efficiency of an energy harvesting device may be approximately linear with input RF power, for input RF power values between the sensitivity threshold

$$( {P}_{i n}^{s e n} )$$

and a first input RF power value greater than

$${P}_{i n}^{s e n} .$$

The energy conversion efficiency may increase linearly with the input RF power from and above

$${P}_{i n}^{s e n} .$$

At input RF powers beyond the linear conversion efficiency zone, the energy conversion efficiency of the energy harvesting device may increase and/or decrease non-linearly with further increases in input RF power. In some examples, the energy conversion efficiency may include one or more additional zones of linear increase (e.g., and/or linear decrease) with input RF power, in addition to an initial linear conversion efficiency zone beginning at the sensitivity threshold

$${P}_{i n}^{s e n} .$$

As discussed previously, certain aspects of the present disclosure relate to wireless communication systems and devices capable of concurrent Wireless Wide Area Network (WWAN) and Radio Frequency ID (RFID) communications. In a wireless communication network environment (e.g., cellular network, etc.), a network device or entity can be used to transmit downlink RF signals to energy harvesting devices. In some cases, the network device can be a UE (e.g., such as a non-energy harvesting UE), a repeater device, or repeater node, an Integrated Access and Backhaul (IAB) node, or other type of network device. In some cases, the network entity can be a base station (e.g., an eNB, a gNB, etc.) or other type of network entity. In some aspects, the network device or entity may also be referred to herein as an “energy source device,” an “energy transmitter device,” a “scheduler of energy transfer,” and/or an “energy transfer scheduler.” For example, a base station, gNB, UE, repeater device or node, and/or an IAB node may each be referred to as an energy source device, an energy transmitter device, a scheduler of energy transfer, and/or an energy transfer scheduler.

In some cases, the network device can be a base station, a gNB, a UE (e.g., such as a non-energy harvesting UE), a repeater device or repeater node, an Integrated Access and Backhaul (IAB) node, etc. In some aspects, the network device may also be referred to herein as an “energy source,” a “scheduler of energy transfer,” and/or an “energy transfer scheduler.” For example, a base station, gNB, UE, repeater device or node, and/or an IAB node may each be referred to as an energy source, a scheduler of energy transfer, and/or an energy transfer scheduler.

For example, a wireless device such as an energy source network device (e.g., base station, gNB, etc.) can read and/or write information stored on ambient energy harvesting IoT devices by transmitting a downlink RF signal. A downlink RF signal can provide energy to an ambient energy harvesting IoT device and can be used as the basis for an information-bearing uplink signal transmitted back to the energy source network device by the ambient energy harvesting IoT device (e.g., based on reflecting or backscattering a portion of the incident downlink RF signal). The energy source network device can read the reflected signal transmitted by an ambient energy harvesting IoT device to decode the information transmitted by the IoT device (e.g., such as sensor information collected by one or more sensors included in the IoT device, etc.).

In an example, disclosed systems include processors or chipsets that can configure one or more antennas to connect and/or communicate with one or more WWAN networks and energize RFID devices such as energy harvesting devices. As noted previously, as used herein, “configuring an antenna” or “reconfiguring an antenna” includes adjusting or tuning receive and/or transmit chains through which a baseband signal is translated from or to a signal compatible with the antenna, and/or includes programming additional functionality, such as impedance and/or antenna aperture tuners to align the antenna to a frequency band of interest. Such systems enable reuse of resources (e.g., processors, antennas, and/or RF systems), which can reduce cost and power consumption in wireless devices (e.g., mobile devices such as UEs). In this manner, antennas and/or compute resources may be dynamically reallocated from WWAN communications to RFID communications and/or from RFID communications to WWAN communications. For instance, an RFID system may emit continuous wave transmissions that energize RFID harvesting devices while simultaneously communicating on one or more WWANs. Such concurrency enables end user applications that use RFID while maintaining connectivity with cellular systems such as NR (5G), LTE, 3G, Global System for Mobile Communications (GSM), Code Division Multiple Access (CDMA), Wideband CDMA (WCDMA), first generation (1×) cellular networks, and so forth. RFID communications may involve emitting an inventory sequence, an example of which is provided in FIG. 8.

FIG. 8 is a diagram illustrating an example of an RFID inventory sequence 800. In particular, FIG. 8 depicts time-division duplexing including alternating transmissions, such as continuous wave (CW) transmissions, and reception of messages from an energy harvesting device, such as a tag (e.g., an RFID tag).

One or more RFID tags may be read in sequence. Sequence 800 includes an example of a single tag read sequence 810 and an example of a multi-tag read sequence 860. As depicted, the single tag read sequence 810 and the multi-tag read sequence 860 both include a sequence of various transmissions and receptions. Sequences 810 and 860 are exemplary and, as such, multiple different variations are possible.

The sequence 810 and the sequence 860 each include various continuous wave segments, during which a continuous wave is emitted via an antenna on a device (e.g., a reader device). The sequence 810 and the sequence 860 each also include various receive segments, during which the device (e.g., the reader device) can listen for transmissions from the one or more RFID tags. The CW energizes any tags located within communications range of the device (e.g., the reader device), or if the tags are already energized, maintains the tags energized before the tags are read.

The single tag read sequence 810 includes continuous wave (CW) 812, select 814, CW 816, query 818, CW 820 (and RN16 message 840), Acknowledgement (ACK) 822, and CW 824 (and EPC message 842). In the single tag read sequence 810, a reader device can use the sequence Query(T)->RN16(R)->ACK(T)->EPC(R) to read one tag, where “T” refers to the reader device transmitting and “R” refers to the reader device receiving (e.g., where the tag is transmitting). For instance, the reader device can first transmit a continuous wave (CW) 812. In the example depicted, the transmission time may be 1.5 milliseconds (ms), but other durations are also possible.

Continuing the example, the reader device can then transmit a Select(T)/Challenge(T) message 814 to one or more of the tags. The reader device can then transmit a second CW 816 for a time T₄. In response, a tag can emit the RN16 message 840, T₁ time after a start of the transmission of the CW 820, and ending at T₂ time prior to the end of the transmission of the CW 820. During this time, the reader device can continue to emit the CW 820. The reader device can respond with an ACK message 822. In response, the tag can emit an EPC message 842, while the reader device continues to emit the CW 824. The EPC message 842 can be emitted T₁ time after the start of the transmission of the CW 824, and ending T₂ time prior to the end of the transmission of the CW 824.

The Electronic Product Code (EPC) Radio-Frequency Identity Generation-2 Ultra High Frequency (UHF) RFID standard (e.g., an RFID specification) provides for a potentially short turnaround time for timers T₁ and T₂. This short turnaround time requires a need for substantial computational resources, in addition to at least one antenna for an RFID application. In some cases, meeting additional requirements may be required. Such requirements may include frequency-hopping spread spectrum (FHSS) signaling for UL signals in the United States (US), and a need to meet anti-jammer requirements in the European Union (EU).

The multi-tag read sequence 860 includes the operations of single tag read sequence 810, followed by one or more repetitions of parts of the sequence 810, such as Query repeat (Rep) 826, CW 828, ACK 830, CW 832, Query Rep 834, RN16 message 844, and EPC message 846. More specifically, multi-tag read sequence 860 includes messages QueryRep(T)->RN16(R)->ACK(T)->EPC(R) to read subsequent tags, which follows the initial message sequence, with a particular pre-defined timing cadence. These messages may be repeated, once for each additional tag.

A duration of the sequences depends upon a particular configuration that the reader device selects for transmitting and receiving data transmissions. In an example, a typical duration of the single tag read sequence 810 is from 1.2 to 50 ms. By contrast, the multi-tag read sequence 860 may range as follows:

$$\{ 1.2 - 50 \} + ( a no\_of \_tags read ) * \{ 0.5 - 41 \} ms$$

In some cases, at least 1.5 ms may be needed to power up tags before sending any commands.

As previously mentioned, the majority of RFID solutions are currently based on bulky gun-form factor devices (e.g., handheld devices in the form of a gun) or attachable RFID devices. For these solutions employing the attachable RFID devices, for performing RFID operations of inventorying tags, users must obtain a separate attachable RFID device and attach the RFID device to a handheld device (e.g., a mobile phone). The gun-form factor devices and attachable RFID devices are very costly (e.g., around a thousand dollars each), but can provide high performance (e.g., a long range and a high read rate).

Currently, integrated RFID solutions, which integrate RFID devices within handheld devices, such as mobile phones, are emerging due to their low cost and new use cases. The performance of these integrated handheld devices is satisfactory for at least short range (e.g., approximately two meters) use cases. In order to meet these ranges, the power amplifier (PA) of the transmitter of these handheld devices must deliver a higher power to the antenna of the handheld device, as compared to WAN radios. Inventorying tags (e.g., RFID tags) within a warehouse or retail store can require a long amount of time (e.g., in minutes) and, as such, the inventory operations can substantially drain the battery of the handheld device. With this higher power, the duty cycle (e.g., which is related to the read rate) of the RFID inventory operations must be significantly reduced in order to meet stringent RF exposure (e.g., SAR) requirements for handheld devices (e.g., mobile phones).

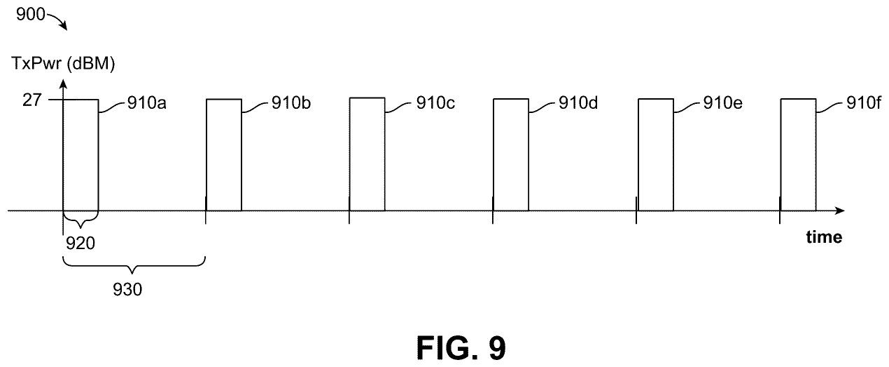

Existing RFID solutions employ a fixed transmit power and a fixed duty cycle for the energizing signals transmitted from reader devices (e.g., integrated handheld devices) to meet a certain range (e.g., two meters) for the tags (e.g., RFID tags). FIG. 9 shows an example of an RFID inventory sequence of energizing signals transmitted with a fixed transmit power and a fixed duty cycle. In particular, FIG. 9 is a graph 900 illustrating an example of a static RFID inventory sequence, where the sequence includes transmissions with a fixed transmit power and a fixed duty cycle 920. In FIG. 9, for the graph 900, the x-axis denotes time in milliseconds (ms) and the y-axis denotes the transmit power (TxPwr) in dBm. The graph 900 shows that the RFID inventory sequence includes a plurality of energizing signals 910a, 910b, 910c, 910d, 910e, 910f that are transmitted by a reader device over a duration of time. In one or more examples, the reader device can be an integrated handheld device, which may be a mobile device (e.g., a mobile phone) with an integrated RFID device. In some examples, each of the energizing signals 910a, 910b, 910c, 910d, 910e, 910f can each include a CW (e.g., and one or more commands, for example the sequence 810 or 860 to read one or more tags).

In one or more examples, the energizing signals 910a, 910b, 910c, 910d, 910e, 910f may be transmitted at a transmission interval 930 of 400 ms. For example, energizing signal 910b may be transmitted 400 ms after energizing signal 910b. As shown in the graph 900, each of the energizing signals 910a, 910b, 910c, 910d, 910e, 910f is transmitted with the same, fixed transmit power (e.g., 27 dBm to cover a maximum two meter range of the tags). The fixed high transmit power (e.g., 27 dBm) can significantly drain the battery of the reader device.

Each of the energizing signals 910a, 910b, 910c, 910d, 910e, 910f is also transmitted with the same, fixed duty cycle 920 (e.g., 100 ms). For meeting one or more RF exposure (e.g., SAR) requirements of the reader device, when transmitting the energizing signals 910a, 910b, 910c, 910d, 910e, 910f at a high power (e.g., 27 dBm), the duty cycle 920 for the transmissions should be short, such as a twenty-five percent (%) duty cycle of 100 ms. This short duty cycle 920 can result in a low read rate (e.g., a rate of the number of tags read per second) for the reader device.

Therefore, improved systems and techniques for inventorying tags (e.g., RFID tags) that reduces power consumption in integrated handheld devices (e.g., reader devices) can be useful.

In one or more aspects, the systems and techniques provide transmit power sweeping in RFID tags. In one or more examples, the systems and techniques provide solutions that adaptively adjust the transmit power of an energizing signal transmitted from a reader device (e.g., an integrated handheld device) to scan tags (e.g., RFID tags) located in different ranges (e.g., one meter, one and half meters, and two meters) from the reader device. The duty cycle of the energizing signal can also be varied for compliance with RF exposure (e.g., SAR) requirements and to allow for an increased read rate.

In one or more examples, the systems and techniques adaptively adjust the transmit power of an energizing signal of a reader device to scan tags in various ranges. In some examples, the transmit power may be progressively increased to first cover (e.g., communicate with) tags located close to the reader device and, then, to cover tags located further away from the reader device. In a typical warehouse or retail store inventory use case, the relative distance from the tags to a reader device spreads (e.g., varies). By employing a lower transmit power for the energizing signals (e.g., including both a CW and data) for tags located nearby the reader device, the battery power of the reader device can be significantly conserved. For example, a reduction of six (6) dBm of transmit power of an energizing signal can reduce the range by half. When using a lower transmit power for the energizing signal, a longer duty cycle for the energizing signal may be employed, while still meeting the RF exposure (e.g., SAR) requirements. The longer duty cycle can lead to an increase in the average read rate of the reader device.

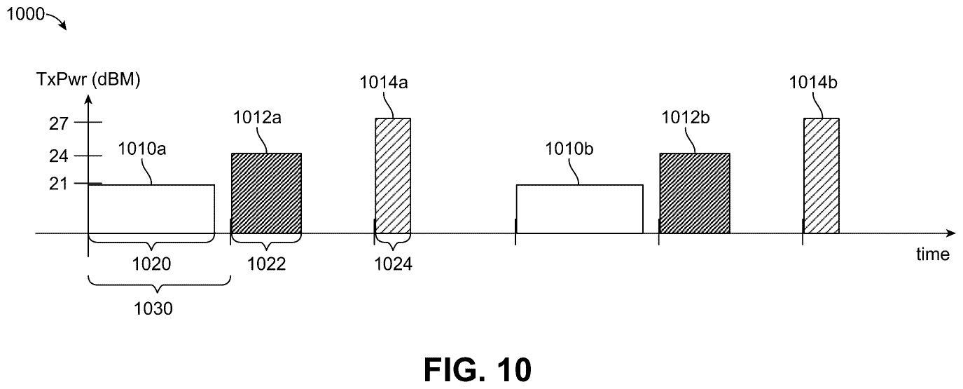

FIG. 10 shows an example of an RFID inventory sequence of energizing signals transmitted with varying transmit power and varying duty cycles. In particular, FIG. 10 is a graph 1000 illustrating an example of a dynamic RFID inventory sequence, where the sequence includes transmissions with varying transmit powers and varying duty cycles 1020, 1022, 1024. In FIG. 10, for the graph 1000, the x-axis denotes time in milliseconds (ms) and the y-axis denotes the transmit power (TxPwr) in dBm. The graph 1000 shows that the RFID inventory sequence includes a plurality of energizing signals 1010a, 1012a, 1014a, 1010b, 1012b, 1014b that are transmitted by a reader device over a duration of time. In some examples, the reader device may be an integrated handheld device, which may be a mobile device, such as a mobile phone, with an integrated RFID device. In one or more examples, each of the energizing signals 1010a, 1012a, 1014a, 1010b, 1012b, 1014b can each include a CW (e.g., and one or more commands, for example the sequence 810 or 860 to read one or more tags).

In one or more examples, the energizing signals 1010a, 1012a, 1014a, 1010b, 1012b, 1014b can be transmitted at a transmission interval 1030 of 400 ms. For example, energizing signal 1012a may be transmitted 400 ms after energizing signal 1010a. As shown in the graph 1000, the energizing signals 1010a, 1012a, 1014a, 1010b, 1012b, 1014b are transmitted with a varied transmit power to cover different ranges of the tags. For example, the energizing signals 1010a, 1010b are transmitted with a low transmit power of twenty-one (21) dBm to cover tags located at a one (1) meter range, the energizing signals 1012a, 1012b are transmitted with a medium transmit power of twenty-four (24) dBm to cover tags located at a one and a half (1.5) meter range, and the energizing signals 1014a, 1014b are transmitted with a high transmit power of twenty-seven (27) dBm to cover tags located at a two (2) meter range. Other transmit powers may be used to cover other ranges or to cover the same ranges in differing hardware configurations or signal environments. Further, while three different transmit powers for three different ranges are illustrated, a greater or fewer quantity of transmit powers to cover a corresponding number of ranges may be implemented.

The graph 1000 also shows that the energizing signals 1010a, 1012a, 1014a, 1010b, 1012b, 1014b are transmitted with varying duty cycles 1020, 1022, 1024. For example, the energizing signals 1010a, 1010b are transmitted with a high duty cycle of ninety (90) %, the energizing signals 1012a, 1012b are transmitted with a medium duty cycle of fifty (50) %, and the energizing signals 1014a, 1014b are transmitted with a low duty cycle of twenty-five (25) %. The higher duty cycles can allow for a higher read rate of the reader device.

In one or more examples, during operation of the systems and techniques for wireless communications performed at the reader device (e.g., a computing device, such as an integrated handheld device), the reader device can transmit, to a plurality of first passive devices (e.g., tags, such as RFID tags) located at a first range (e.g., 1 meter) from the reader device, a first signal (e.g., energizing signal 1010a) with a first transmit power (e.g., 21 dBm) and a first duty cycle 1020 (e.g., 90%). In one or more examples, the first transmit power (e.g., 21 dBm) can be dependent upon the first range (e.g., 1 meter). In one or more examples, the reader device can receive a respective first backscatter signal from each first passive device of the plurality of first passive devices in response to the plurality of first passive devices receiving the first signal (e.g., energizing signal 1010a).

The reader device can transmit, to a plurality of second passive devices (e.g., tags, such as RFID tags) located at a second range (e.g., 1.5 meters) from the reader device, a second signal (e.g., energizing signal 1012a) with a second transmit power (e.g., 24 dBm) and a second duty cycle 1022 (e.g., 50%). In one or more examples, the second transmit power (e.g., 24 dBm) can be dependent upon the second range (e.g., 1.5 meters). In some examples, the first range (e.g., 1 meter) can be less than the second range (e.g., 1.5 meters). In one or more examples, the first transmit power (e.g., 21 dBm) can be less than the second transmit power (e.g., 24 dBm). In some examples, the first duty cycle 1020 (e.g., 90%) can be greater than the second duty cycle 1022 (e.g., 50%). The reader device can receive a respective second backscatter signal from each second passive device of the plurality of second passive devices in response to the plurality of second passive devices receiving the second signal (e.g., energizing signal 1012a).

In some examples, the reader device can transmit, to a plurality of third passive devices (e.g., tags, such as RFID tags) located at a third range (e.g., 2 meters) from the reader device, a third signal (e.g., energizing signal 1014a) with a third transmit power (e.g., 27 dBm) and a third duty cycle 1024 (e.g., 25%). In one or more examples, the third transmit power (e.g., 27 dBm) can be dependent upon the third range (e.g., 2 meters). In some examples, the third range (e.g., 2 meters) can be greater than the second range (e.g., 1.5 meters). In one or more examples, the third transmit power (e.g., 27 dBm) can be greater than the second transmit power (e.g., 24 dBm). In some examples, the third duty cycle 1024 (e.g., 25%) can be less than the second duty cycle 1022 (e.g., 50%). In one or more examples, the reader device can receive a respective third backscatter signal from each third passive device of the plurality of third passive devices in response to the plurality of third passive devices receiving the third signal (e.g., energizing signal 1014a).

In one or more examples, the first duty cycle 1020 (e.g., 90%) can be inversely proportional to the first transmit power (e.g., 21 dBm). In some examples, the second duty cycle 1022 (e.g., 50%) can be inversely proportional to the second transmit power (e.g., 24 dBm). In one or more examples, the first duty cycle 1020 (e.g., 90%) and the second duty cycle 1022 (e.g., 50%) can be each dependent upon an RF exposure (e.g., SAR) requirement for the reader device. In some examples, the first signal (e.g., energizing signal 1010a) and the second signal (e.g., energizing signal 1012a) can each include a respective CW. In one or more examples, the reader device can be a mobile device, such as a mobile phone. In some examples, each first passive device of the plurality of first passive devices can be a RFID tag. In one or more examples, each second passive device of the plurality of second passive devices can be an RFID tag. In some examples, each third passive device of the plurality of third passive devices can be an RFID tag.

In one or more examples, during operation of the systems and techniques for wireless communications performed at a passive device (e.g., a tag, such as an RFID tag), the passive device can receive, from a reader device located at a range (e.g., 1 meter) from the passive device, a first signal (e.g., energizing signal 1010a) with a first transmit power (e.g., 21 dBm) and a first duty cycle 1020 (e.g., 90%). In one or more examples, the first transmit power (e.g., 21 dBm) can be dependent upon the range (e.g., 1 meter). The passive device can transmit, to the reader device based on receiving the first signal (e.g., energizing signal 1010a) from the reader device, a first backscatter signal including information associated with the passive device. In one or more examples, the information associated with the passive device can include a tag identification (TID) and/or an EPC.

The passive device can receive, from the reader device, a second signal (e.g., energizing signal 1012a) with a second transmit power (e.g., 24 dBm) and a second duty cycle 1022 (e.g., 50%). In one or more examples, the first transmit power (e.g., 21 dBm) can be less than the second transmit power (e.g., 24 dBm). In some examples, the first duty cycle 1020 (e.g., 90%) can be greater than the second duty cycle 1022 (e.g., 50%).

In one or more aspects, an inventory state of the passive devices (e.g., tags, such as RFID tags) may be set (e.g., changed, such as by using a session ID, for example S2 and/or S3) such that inventoried tags do not respond to the reader device repetitively, which can be redundant and cause unnecessary air interference. In one or more examples, the passive device (e.g., a tag, such as an RFID tag) can change, based on receiving a first signal (e.g., energizing signal 1010a) and/or in response transmitting a first backscatter signal to the reader device, an inventory state of the passive device from a first state (e.g., state A) to a second state (e.g., state B). For example, the reader device may transmit a session ID to the passive devices in the first signal (e.g., energizing signal 1010a). In some examples, the passive device can change, based on expiration of a specific duration of time (e.g., which may be referred to as a “persistent time”), the inventory state of the passive device from the second state (e.g., state B) to the first state (e.g., state A). In one or more examples, the passive device can transmit, to the reader device based on receiving the second signal (e.g., energizing signal 1012a) from the reader device and on the inventory state being changed from the second state (e.g., state B) to the first state (e.g., state A), a second backscatter signal. In some examples, the passive device does not transmit backscatter signals until the inventory state of the passive device has been changed from the second state (e.g., state B) back to the first state (e.g., state A). For example, the passive device may determine whether it is in the first state or the second state, and selectively transmit a backscatter signal based on the determination. In some examples, state A is representative of a session ID not being stored by or accepted by the passive device, and state B is representative of a session ID having been stored by or accepted by the passive device. In some examples, the session ID is different for each distance range (e.g., first range through third range) or is unique to each signal (1010, 1012, 1014 or 1010a, 1010b, etc.), or the session ID may be the same for all ranges or signals.

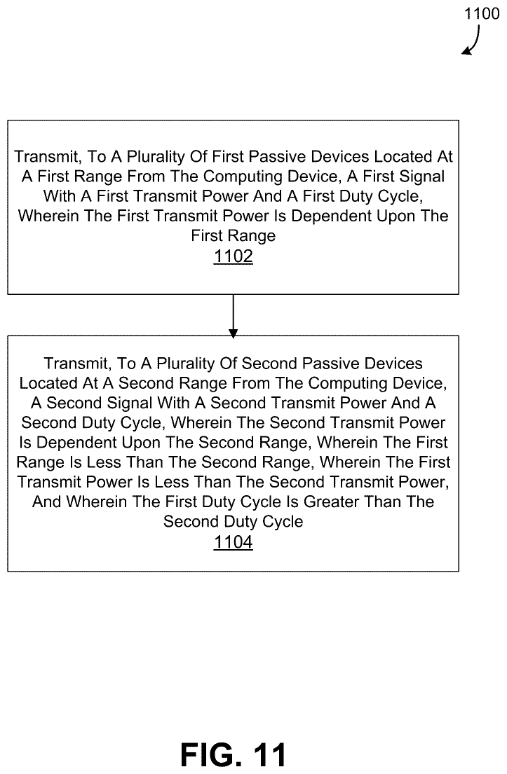

FIG. 11 is a flow chart illustrating an example of a process 1100 for wireless communications at a computing device. The process 1100 can be performed by a computing device (e.g., a reader device, a computing device having the processing system 1300 of FIG. 13, or other device) or by a component or system (e.g., a chipset, one or more processors central processing units (CPUs), digital signal processors (DSPs), graphics processing units (GPUs), any combination thereof, and/or other type of processor(s), or other component or system) of the computing device. The computing device can include or can be a reader device, such as a mobile device. The operations of the process 1100 may be implemented as software components that are executed and run on one or more processors (e.g., processor 1310 of FIG. 13, or other processor(s)). Further, the transmission and reception of signals by the computing device in the process 1100 may be enabled, for example, by one or more antennas and/or one or more transceivers (e.g., wireless transceiver(s)).

At block 1102, the computing device (or component thereof) can transmit (or output for transmission), to a plurality of first passive devices (e.g., a first plurality of RFID tags) located at a first range from the computing device, a first signal with a first transmit power and a first duty cycle. The first transmit power is dependent upon the first range. In some aspects, the first duty cycle is inversely proportional to the first transmit power.

At block 1104, the computing device (or component thereof) can transmit (or output for transmission), to a plurality of second passive devices (e.g., a second plurality of RFID tags) located at a second range from the computing device, a second signal with a second transmit power and a second duty cycle. For instance, as illustrated in FIG. 10, various energizing signals (e.g., energizing signals 1010a, 1012a, 1014a, 1010b, 1012b, and/or 1014b) can be transmitted with a varied transmit power to cover different ranges of the tags, where the energizing signals (e.g., energizing signals 1010a, 1012a, 1014a, 1010b, 1012b, and/or 1014b) can be transmitted with varying duty cycles (e.g., duty cycles 1020, 1022, and/or 1024). In some aspects, the first signal and the second signal each include a respective continuous wave (CW) (e.g., are separate portions of a same CW, are separate CW transmissions, etc.). The first range is less than the second range. The second transmit power is dependent upon the second range. The first transmit power is less than the second transmit power, and the first duty cycle is greater than the second duty cycle. In some aspects, the second duty cycle is inversely proportional to the second transmit power. In some cases, the first duty cycle and the second duty cycle are dependent upon the first transmit power and the second transmit power, respectively, and an RF exposure (e.g., specific absorption rate (SAR)) requirement for the computing device.

In some aspects, the computing device (or component thereof) can receive a respective first backscatter signal from each first passive device of the plurality of first passive devices in response to the plurality of first passive devices receiving the first signal. The computing device (or component thereof) can also receive a respective second backscatter signal from each second passive device of the plurality of second passive devices in response to the plurality of second passive devices receiving the second signal.

In some aspects, the computing device (or component thereof) can transmit (or output for transmission), to a plurality of third passive devices located at a third range from the computing device, a third signal with a third transmit power and a third duty cycle. The third transmit power is dependent upon the third range, where the third range is greater than the second range. The third transmit power is greater than the second transmit power, and the third duty cycle is less than the second duty cycle. In such aspects, the first signal is transmitted before the second and third signals and the second signal is transmitted before the third signal. In some cases, the computing device (or component thereof) can receive a respective third backscatter signal from each third passive device of the plurality of third passive devices in response to the plurality of third passive devices receiving the third signal.

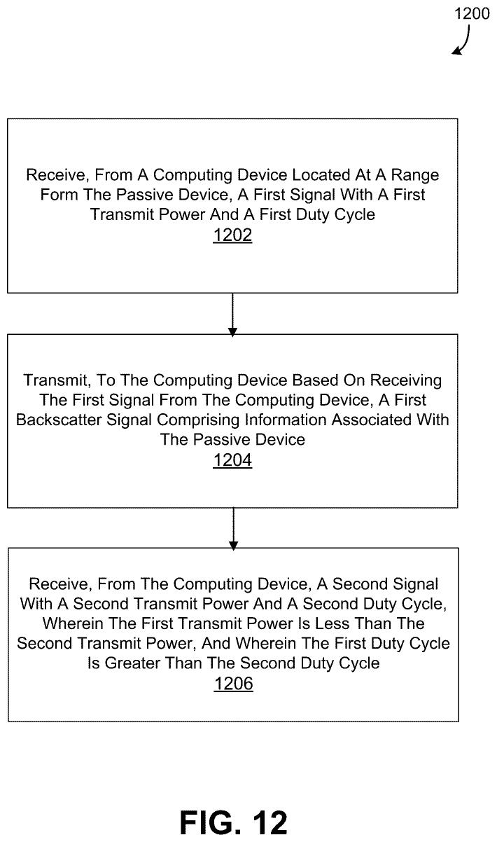

FIG. 12 is a flow chart illustrating an example of a process 1200 for wireless communications at a passive device. The process 1200 can be performed by a passive device (e.g., a tag, such as an RFID tag, an RF energy harvesting device such as the RF energy harvesting device 500 of FIG. 5, a passive device having the processing system 1300 of FIG. 13, or other type of passive device) or by a component or system (e.g., a chipset, one or more processors central processing units (CPUs), digital signal processors (DSPs), graphics processing units (GPUs), any combination thereof, and/or other type of processor(s), or other component or system) of the passive device. The operations of the process 1200 may be implemented as software components that are executed and run on one or more processors (e.g., processor 1310 of FIG. 13, or other processor(s)). Further, the transmission and reception of signals by the passive device in the process 1200 may be enabled, for example, by one or more antennas and/or one or more transceivers (e.g., wireless transceiver(s)).

At block 1202, the passive device (or component thereof) can receive, from a computing device located at a range from the passive device, a first signal with a first transmit power and a first duty cycle. In some cases, the computing device can include or can be a reader device, such as a mobile device. For instance, as described with respect to FIG. 10, a passive device can receive, from a reader device located at a range (e.g., 1 meter) from the passive device, a first signal (e.g., energizing signal 1010a) with a first transmit power (e.g., 21 dBm) and a first duty cycle 1020 (e.g., 90%), where the first transmit power (e.g., 21 dBm) can be dependent upon the range (e.g., 1 meter).

At block 1204, the passive device (or component thereof) can transmit (or output for transmission), to the computing device based on receiving the first signal from the computing device, a first backscatter signal including information associated with the passive device. For example, as described with respect to FIG. 10, the passive device can transmit, to the reader device based on receiving the first signal (e.g., energizing signal 1010a) from the reader device, a first backscatter signal including information associated with the passive device. In some aspects, the information associated with the passive device includes at least one of a tag identification (TID) or an electronic product code (EPC) (e.g., in the EPC message 842 of FIG. 8).

At block 1206, the passive device (or component thereof) can receive, from the computing device, a second signal with a second transmit power and a second duty cycle. The first transmit power is less than the second transmit power, and the first duty cycle is greater than the second duty cycle. For instance, again referring to FIG. 10 as an illustrative example, the passive device can receive, from the reader device, a second signal (e.g., energizing signal 1012a) with a second transmit power (e.g., 24 dBm) and a second duty cycle 1022 (e.g., 50%), where the first transmit power (e.g., 21 dBm) can be less than the second transmit power (e.g., 24 dBm) and the first duty cycle 1020 (e.g., 90%) can be greater than the second duty cycle 1022 (e.g., 50%).

In some aspects, the passive device (or component thereof) can change, based on transmitting the first backscatter signal to the computing device, an inventory state of the passive device from a first state to a second state. For instance, as described with respect to FIG. 10, an inventory state of the passive devices (e.g., tags, such as RFID tags) may be set and/or changed (e.g., by using a session ID, for example S2 and/or S3) so that tags that have already been inventoried do not respond to the computing device (e.g., reader device) repetitively, which can be redundant and cause unnecessary air interference. The passive device (e.g., a tag, such as an RFID tag) can change, based on receiving a first signal (e.g., energizing signal 1010a) and/or in response transmitting a first backscatter signal to the reader device, an inventory state of the passive device from a first state (e.g., state A) to a second state (e.g., state B). In some cases, the reader device may transmit a session ID to the passive devices in the first signal (e.g., energizing signal 1010a). In some cases, the passive device (or component thereof) can change, based on expiration of a specific duration of time (e.g., a persistence time), the inventory state of the passive device from the second state to the first state. In some examples, the passive device (or component thereof) can transmit (or output for transmission), to the computing device based on receiving the second signal from the computing device and on the inventory state being changed from the second state to the first state, a second backscatter signal. In some cases, the passive device does not transmit backscatter signals until the inventory state of the passive device has been changed from the second state to the first state.

In some cases, the computing device of process 1100 and process 1200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1100 and process 1200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1100 and process 1200 is each illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1100 and process 1200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a processing system 1300, which may be employed for transmit power sweeping in RFID tags. In particular, FIG. 13 illustrates an example of processing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, processing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Processing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, processing system 1300 includes an input device 1345, which can represent any number of input mechanisms, such as a microphone for speech, a touch-sensitive screen for gesture or graphical input, keyboard, mouse, motion input, speech, etc. Processing system 1300 can also include output device 1335, which can be one or more of a number of output mechanisms. In some instances, multimodal systems can enable a user to provide multiple types of input/output to communicate with processing system 1300.

Processing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LiDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more receivers or transceivers that are used to determine a location of the processing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for wireless communications, the apparatus comprising: a processing system configured to: output, for transmission to a plurality of first passive devices located at a first range from the apparatus, a first signal with a first transmit power and a first duty cycle, wherein the first transmit power is dependent upon the first range; and output, for transmission to a plurality of second passive devices located at a second range from the apparatus, a second signal with a second transmit power and a second duty cycle, wherein the second transmit power is dependent upon the second range, wherein the first range is less than the second range, wherein the first transmit power is less than the second transmit power, and wherein the first duty cycle is greater than the second duty cycle.

Aspect 2. The apparatus of Aspect 1, wherein the processing system is configured to: receive a respective first backscatter signal from each first passive device of the plurality of first passive devices in response to the plurality of first passive devices receiving the first signal; and receive a respective second backscatter signal from each second passive device of the plurality of second passive devices in response to the plurality of second passive devices receiving the second signal.

Aspect 3. The apparatus of any of Aspects 1 or 2, wherein the processing system is configured to output, for transmission to a plurality of third passive devices located at a third range from the apparatus, a third signal with a third transmit power and a third duty cycle, wherein the third transmit power is dependent upon the third range, wherein the third range is greater than the second range, wherein the third transmit power is greater than the second transmit power, wherein the third duty cycle is less than the second duty cycle, and wherein the first signal is transmitted before the second and third signals and wherein the second signal is transmitted before the third signal.

Aspect 4. The apparatus of Aspect 3, wherein the processing system is configured to receive a respective third backscatter signal from each third passive device of the plurality of third passive devices in response to the plurality of third passive devices receiving the third signal.

Aspect 5. The apparatus of any of Aspects 1 to 4, wherein the first duty cycle is inversely proportional to the first transmit power, and wherein the second duty cycle is inversely proportional to the second transmit power.

Aspect 6. The apparatus of any of Aspects 1 to 5, wherein the first duty cycle and the second duty cycle are dependent upon the first transmit power and the second transmit power, respectively, and a specific absorption rate (SAR) requirement for the apparatus.

Aspect 7. The apparatus of any of Aspects 1 to 6, wherein the first signal and the second signal each comprise a respective continuous wave (CW).

Aspect 8. The apparatus of any of Aspects 1 to 7, wherein the apparatus is a mobile device.

Aspect 9. The apparatus of any of Aspects 1 to 8, wherein each first passive device of the plurality of first passive devices is a radio frequency identification (RFID) tag, and wherein each second passive device of the plurality of second passive devices is an RFID tag.

Aspect 10. A passive device for wireless communications, the passive device comprising: a processing system configured to: receive, from a computing device located at a range from the passive device, a first signal with a first transmit power and a first duty cycle; output, for transmission to the computing device based on receiving the first signal from the computing device, a first backscatter signal comprising information associated with the passive device; and receive, from the computing device, a second signal with a second transmit power and a second duty cycle, wherein the first transmit power is less than the second transmit power, and wherein the first duty cycle is greater than the second duty cycle.

Aspect 11. The passive device of Aspect 10, wherein the processing system is configured to change, based on transmitting the first backscatter signal to the computing device, an inventory state of the passive device from a first state to a second state.

Aspect 12. The passive device of Aspect 11, wherein the processing system is configured to change, based on expiration of a specific duration of time, the inventory state of the passive device from the second state to the first state.

Aspect 13. The passive device of Aspect 12, wherein the processing system is configured to output, for transmission to the computing device based on receiving the second signal from the computing device and on the inventory state being changed from the second state to the first state, a second backscatter signal.

Aspect 14. The passive device of any of Aspects 11 to 13, wherein the passive device does not transmit backscatter signals until the inventory state of the passive device has been changed from the second state to the first state.

Aspect 15. The passive device of any of Aspects 10 to 14, wherein the information associated with the passive device comprises at least one of a tag identification (TID) or an electronic product code (EPC).

Aspect 16. The passive device of any of Aspects 10 to 15, wherein the passive device is a radio frequency identification (RFID) tag.

Aspect 17. The passive device of any of Aspects 10 to 16, wherein the computing device is a mobile device.

Aspect 18. A method for wireless communications performed at a computing device, the method comprising: transmitting, to a plurality of first passive devices located at a first range from the computing device, a first signal with a first transmit power and a first duty cycle, wherein the first transmit power is dependent upon the first range; and transmitting, to a plurality of second passive devices located at a second range from the computing device, a second signal with a second transmit power and a second duty cycle, wherein the second transmit power is dependent upon the second range, wherein the first range is less than the second range, wherein the first transmit power is less than the second transmit power, and wherein the first duty cycle is greater than the second duty cycle.

Aspect 19. The method of Aspect 18, further comprising: receiving a respective first backscatter signal from each first passive device of the plurality of first passive devices in response to the plurality of first passive devices receiving the first signal; and receiving a respective second backscatter signal from each second passive device of the plurality of second passive devices in response to the plurality of second passive devices receiving the second signal.

Aspect 20. The method of any of Aspects 18 or 19, further comprising transmitting, to a plurality of third passive devices located at a third range from the computing device, a third signal with a third transmit power and a third duty cycle, wherein the third transmit power is dependent upon the third range, wherein the third range is greater than the second range, wherein the third transmit power is greater than the second transmit power, wherein the third duty cycle is less than the second duty cycle, wherein the first signal is transmitted before the second and third signals and wherein the second signal is transmitted before the third signal.

Aspect 21. The method of Aspect 20, further comprising receiving a respective third backscatter signal from each third passive device of the plurality of third passive devices in response to the plurality of third passive devices receiving the third signal.

Aspect 22. The method of any of Aspects 18 to 21, wherein the first duty cycle is inversely proportional to the first transmit power, and wherein the second duty cycle is inversely proportional to the second transmit power.

Aspect 23. The method of any of Aspects 18 to 22, wherein the first duty cycle and the second duty cycle are dependent upon the first transmit power and the second transmit power, respectively, and a specific absorption rate (SAR) requirement for the computing device.

Aspect 24. The method of any of Aspects 18 to 23, wherein the first signal and the second signal each comprise a respective continuous wave (CW).

Aspect 25. The method of any of Aspects 18 to 24, wherein the computing device is a mobile device.

Aspect 26. The method of any of Aspects 18 to 25, wherein each first passive device of the plurality of first passive devices is a radio frequency identification (RFID) tag, and wherein each second passive device of the plurality of second passive devices is an RFID tag.

Aspect 27. A method for wireless communications performed at a passive device, the method comprising: receiving, from a computing device located at a range from the passive device, a first signal with a first transmit power and a first duty cycle; transmitting, to the computing device based on receiving the first signal from the computing device, a first backscatter signal comprising information associated with the passive device; and receiving, from the computing device, a second signal with a second transmit power and a second duty cycle, wherein the first transmit power is less than the second transmit power, and wherein the first duty cycle is greater than the second duty cycle.

Aspect 28. The method of Aspect 27, further comprising changing, based on transmitting the first backscatter signal to the computing device, an inventory state of the passive device from a first state to a second state.

Aspect 29. The method of Aspect 28, further comprising changing, based on expiration of a specific duration of time, the inventory state of the passive device from the second state to the first state.

Aspect 30. The method of Aspect 29, further comprising transmitting, to the computing device based on receiving the second signal from the computing device and on the inventory state being changed from the second state to the first state, a second backscatter signal.

Aspect 31. The method of any of Aspects 28 to 30, wherein the passive device does not transmit backscatter signals until the inventory state of the passive device has been changed from the second state to the first state.

Aspect 32. The method of any of Aspects 27 to 31, wherein the information associated with the passive device comprises at least one of a tag identification (TID) or an electronic product code (EPC).

Aspect 33. The method of any of Aspects 27 to 32, wherein the passive device is a radio frequency identification (RFID) tag.

Aspect 34. The method of any of Aspects 27 to 33, wherein the computing device is a mobile device.

Aspect 35. A non-transitory computer-readable medium having stored thereon instructions that, when executed by at least one processor, cause the at least one processor to perform operations according to any of Aspects 18 to 26.

Aspect 36. An apparatus for wireless communications, the apparatus including one or more means for performing operations according to any of Aspects 18 to 26.

Aspect 37. A non-transitory computer-readable medium having stored thereon instructions that, when executed by at least one processor, cause the at least one processor to perform operations according to any of Aspects 27 to 34.

Aspect 38. An apparatus for wireless communications, the apparatus including one or more means for performing operations according to any of Aspects 27 to 34.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for wireless communications, the apparatus comprising:
a processing system configured to:
output, for transmission to a plurality of first passive devices located at a first range from the apparatus, a first signal with a first transmit power and a first duty cycle, wherein the first transmit power is dependent upon the first range; and
output, for transmission to a plurality of second passive devices located at a second range from the apparatus, a second signal with a second transmit power and a second duty cycle, wherein the second transmit power is dependent upon the second range, wherein the first range is less than the second range, wherein the first transmit power is less than the second transmit power, and wherein the first duty cycle is greater than the second duty cycle.

2. The apparatus of claim 1, wherein the processing system is configured to:
receive a respective first backscatter signal from each first passive device of the plurality of first passive devices in response to the plurality of first passive devices receiving the first signal; and
receive a respective second backscatter signal from each second passive device of the plurality of second passive devices in response to the plurality of second passive devices receiving the second signal.

3. The apparatus of claim 1, wherein the processing system is configured to output, for transmission to a plurality of third passive devices located at a third range from the apparatus, a third signal with a third transmit power and a third duty cycle, wherein the third transmit power is dependent upon the third range, wherein the third range is greater than the second range, wherein the third transmit power is greater than the second transmit power, wherein the third duty cycle is less than the second duty cycle, and wherein the first signal is transmitted before the second and third signals and wherein the second signal is transmitted before the third signal.

4. The apparatus of claim 3, wherein the processing system is configured to receive a respective third backscatter signal from each third passive device of the plurality of third passive devices in response to the plurality of third passive devices receiving the third signal.

5. The apparatus of claim 1, wherein the first duty cycle is inversely proportional to the first transmit power, and wherein the second duty cycle is inversely proportional to the second transmit power.

6. The apparatus of claim 1, wherein the first duty cycle and the second duty cycle are dependent upon the first transmit power and the second transmit power, respectively, and a specific absorption rate (SAR) requirement for the apparatus.

7. The apparatus of claim 1, wherein the first signal and the second signal each comprise a respective continuous wave (CW).

8. The apparatus of claim 1, wherein each first passive device of the plurality of first passive devices is a radio frequency identification (RFID) tag, and wherein each second passive device of the plurality of second passive devices is an RFID tag.

9. A passive device for wireless communications, the passive device comprising:
a processing system configured to:
receive, from a computing device located at a range from the passive device, a first signal with a first transmit power and a first duty cycle;
output, for transmission to the computing device based on receiving the first signal from the computing device, a first backscatter signal comprising information associated with the passive device; and
receive, from the computing device, a second signal with a second transmit power and a second duty cycle, wherein the first transmit power is less than the second transmit power, and wherein the first duty cycle is greater than the second duty cycle.

10. The passive device of claim 9, wherein the processing system is configured to change, based on transmitting the first backscatter signal to the computing device, an inventory state of the passive device from a first state to a second state.

11. The passive device of claim 10, wherein the processing system is configured to change, based on expiration of a specific duration of time, the inventory state of the passive device from the second state to the first state.

12. The passive device of claim 11, wherein the processing system is configured to output, for transmission to the computing device based on receiving the second signal from the computing device and on the inventory state being changed from the second state to the first state, a second backscatter signal.

13. The passive device of claim 10, wherein the passive device does not transmit backscatter signals until the inventory state of the passive device has been changed from the second state to the first state.

14. The passive device of claim 9, wherein the information associated with the passive device comprises at least one of a tag identification (TID) or an electronic product code (EPC).

15. The passive device of claim 9, wherein the passive device is a radio frequency identification (RFID) tag.

16. A method for wireless communications performed at a passive device, the method comprising:
receiving, from a computing device located at a range from the passive device, a first signal with a first transmit power and a first duty cycle;
transmitting, to the computing device based on receiving the first signal from the computing device, a first backscatter signal comprising information associated with the passive device; and
receiving, from the computing device, a second signal with a second transmit power and a second duty cycle, wherein the first transmit power is less than the second transmit power, and wherein the first duty cycle is greater than the second duty cycle.

17. The method of claim 16, further comprising changing, based on transmitting the first backscatter signal to the computing device, an inventory state of the passive device from a first state to a second state.

18. The method of claim 17, further comprising changing, based on expiration of a specific duration of time, the inventory state of the passive device from the second state to the first state.

19. The method of claim 18, further comprising transmitting, to the computing device based on receiving the second signal from the computing device and on the inventory state being changed from the second state to the first state, a second backscatter signal.

20. The method of claim 17, wherein the passive device does not transmit backscatter signals until the inventory state of the passive device has been changed from the second state to the first state.
